(19) United States
(12) Patent Application Publication
(10) Pub. No.: US 2025/0168307 A1
(43) Pub. Date: May 22, 2025

(54) APPARATUS FOR AND METHOD FOR IMAGE PROCESSING

(71) Applicants: SAMSUNG ELECTRONICS CO., LTD., Suwon-si (KR); EWHA UNIVERSITY - INDUSTRY COLLABORATION FOUNDATION, Seoul (KR)

(72) Inventors: Woo-Shik KIM, Suwon-si (KR); Hyejin OH, Seoul (KR); Jewon KANG, Seoul (KR); Sangyoon LEE, Suwon-si (KR); Heejin CHOI, Suwon-si (KR); Yungkyung PARK, Seoul (KR)

(73) Assignees: SAMSUNG ELECTRONICS CO., LTD., Suwon-si (KR); EWHA UNIVERSITY - INDUSTRY COLLABORATION FOUNDATION, Seoul (KR)

(21) Appl. No.: 18/800,432

(22) Filed: Aug. 12, 2024

(30) Foreign Application Priority Data
Nov. 17, 2023 (KR) 10-2023-0159707

(51) Int. Cl. H04N 9/73; G06V 10/60; G06V 10/82

(52) U.S. Cl. CPC H04N 9/73; G06V 10/60; G06V 10/82

(57) ABSTRACT

An apparatus for obtaining an image may include a multispectral image sensor configured to obtain an image through four or more channels, and a processor configured to estimate illumination information by inputting the obtained image to a pre-trained deep learning network and perform color transformation for the obtained image based on the estimated illumination information, wherein the deep learning network learns a channel correlation between the channels to output the estimated illumination information.

### CROSS-REFERENCE TO RELATED APPLICATION

This application is based on and claims priority to Korean Patent Application No. 10-2023-0159707, filed on Nov. 17, 2023, in the Korean Intellectual Property Office, the disclosure of which is incorporated by reference herein in its entirety.

### BACKGROUND

### 1. Field

The disclosure relates to a method and apparatus for obtaining an image.

### 2. Description of the Related Art

An image sensor captures light from a subject and converts it into an electrical signal through photoelectric transformation.

For color expression, an image sensor generally uses a color filter consisting of an array of filter elements that selectively transmit red, green, and blue light. By measuring the amount of light transmitted through each filter, the image sensor forms a color image of the subject through image processing.

Because a sensing value obtained by the image sensor is affected by illumination, the accuracy of color representation in an image captured by a camera is also affected by illumination. White balancing may be used to mitigate the impact of varying illumination on the received color of images and to capture a unique color of an object as much as possible.

White balance technology in the related art involves capturing a red-green-blue (RGB) image and then performing white balance adjustments by analyzing information from the RGB image. Because this method is based on the Gray World Assumption, that is, the assumption that the average values of images for R, G, and B channels are the same, or other constraints, the method may not work correctly in situations where such constraints are not satisfied.

### SUMMARY

One or more embodiments provide a method and apparatus for obtaining an image. The technical objectives to be achieved by the disclosure are not limited to the technical objectives described above, and other technical objectives may be inferred from the following embodiments.

According to an aspect of the present disclosure, an apparatus for image processing may include: a multispectral image sensor configured to obtain an image through a plurality of channels; and a processor configured to estimate illumination information by inputting the obtained image to a neural network and perform color transformation on the obtained image based on the estimated illumination information, wherein the neural network is trained based on information of a channel correlation between the plurality of channels to output the estimated illumination information.

The processor may be further configured to input the channel correlation to at least one of a plurality of layers constituting the neural network.

The channel correlation may include at least one of a first channel correlation between first channels and a second channel correlation between second channels, the first channels corresponding to the obtained image, and the second channels corresponding to an intermediate image output from one of the plurality of layers.

The neural network may include: a convolution block including a plurality of convolution layers; and a channel attention block following at least one of the plurality of convolution layers, wherein the channel attention block may include a pooling layer and a first fully connected layer.

The processor is further configured to generate a first channel vector by performing global pooling on the image and add the first channel vector to an output result of the first fully connected layer.

The processor is further configured to generate a second channel vector by performing global pooling on an intermediate image output from a first convolution layer among the plurality of convolution layers, the channel attention block follows a second convolution layer following the first convolution layer, and the second channel vector is added to an output result of the first fully connected layer.

The channel attention block is configured to apply either one or both of a rectified linear unit (ReLU) function and a sigmoid function.

The neural network may include at least one self-attention layer configured to learn the channel correlation.

The neural network is pre-trained by using a loss function including a first angular error and a second angular error, the first angular error is based on first ground truth illumination information and first estimation illumination information regarding a training image for training the neural network, and the second angular error is based on second illumination information and second estimation illumination information that are obtained by transforming the first ground truth illumination information and the first estimation illumination information into an XYZ color space by using color matching function, respectively.

When the obtained image is a mixed illumination image obtained from an environment where a first illumination source and a second illumination source are present, the processor is further configured to divide the mixed illumination image into divided regions, estimate first illumination information based on a first region where the first illumination source is dominant among the divided regions, estimate second illumination information based on a second region where the second illumination source is dominant among the divided regions, and estimate mixed illumination information regarding the mixed illumination image based on the first illumination information and the second illumination information.

The processor is further configured to adjust a dimension of an illumination vector corresponding to the estimated illumination information to be greater than a number of channels corresponding to the obtained image or adjust the dimension of the illumination vector to 3.

The neural network may include: a three-dimensional (3D) convolution layer configured to perform 3D convolution based on the plurality of channels and a two-dimensional (2D) image corresponding to the obtained image; and a spectral channel attention block following the 3D convolution layer.

The neural network may include a spectral self-attention layer configured to learn the channel correlation.

A method for image processing may include: obtaining an image through a plurality of channels by using a multispectral image sensor; estimating illumination information by inputting the obtained image to a neural network; and based on the estimated illumination information, performing color transformation for the obtained image, wherein the neural network is trained using a channel correlation between the plurality of channels to output the estimated illumination information.

The estimating of the illumination information may include: inputting the obtained image to the neural network; and inputting the channel correlation to at least one of a plurality of layers constituting the neural network.

The channel correlation may include at least one of a first channel correlation between first channels and a second channel correlation between second channels, the first channels corresponding to the obtained image, and the second channels corresponding to an intermediate image output from at least one of the plurality of layers.

The neural network may include a convolution block including a plurality of convolution layers; and a channel attention block following at least one of the plurality of convolution layers, wherein the channel attention block may include a pooling layer and a first fully connected layer.

The estimating of the illumination information may include: generating a first channel vector by performing global pooling on the obtained image; and adding the first channel vector to an output result of the first fully connected layer.

The estimating of the illumination information may include: generating a second channel vector by performing global pooling on an intermediate image output from a first convolution layer among the plurality of convolution layers; an adding the second channel vector to an output result of the first fully connected layer, wherein the channel attention block follows a second convolution layer following the first convolution layer.

The estimating of the illumination information may include adjusting a dimension of an illumination vector corresponding to the estimated illumination information to be greater than a number of channels corresponding to the obtained image or adjusting the dimension of the illumination vector to 3.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an apparatus for obtaining an image according to an embodiment;

FIG. 2A is a diagram of a wavelength spectrum of a red-green-blue (RGB) sensor, according to an embodiment;

FIG. 2B is a diagram of a wavelength spectrum of a multispectral image sensor, according to an embodiment;

FIG. 2C is a diagram of a wavelength spectrum of a multispectral image sensor, according to another embodiment;

FIG. 3 is a cross-sectional view of a multispectral image sensor according to an embodiment;

FIG. 4 is a pixel arrangement of a multispectral image sensor, according to an embodiment;

FIG. 5A is a diagram of a raw image obtained from the multispectral image sensor of FIG. 1;

FIG. 5B is a diagram of a channel-wise image obtained from the multispectral image sensor of FIG. 1 after demosaicing is performed;

FIG. 6 is a diagram for describing a deep learning network to estimate illumination information, according to an embodiment;

FIG. 7 is a diagram for describing a deep learning network to estimate illumination information, according to another embodiment;

FIG. 8A is a diagram for describing a channel attention block of FIG. 7, according to an embodiment;

FIG. 8B is a diagram for describing a channel attention block of FIG. 7, according to another embodiment;

FIG. 9A is a diagram for describing a structure of a transformer, according to an embodiment;

FIG. 9B is a diagram for describing a structure of a multi-head attention layer of FIG. 9A;

FIG. 9C is a diagram illustrating a calculation result of the multi-head attention layer of FIG. 9B;

FIG. 10 is a diagram for describing a deep learning network to estimate illumination information, according to another embodiment;

FIG. 11A is a diagram for describing a deep learning network including a three-dimensional (3D) convolution layer;

FIG. 11B is a diagram for describing a spectral channel attention block of FIG. 11A;

FIG. 11C is a diagram for describing a spectral self-attention block of FIG. 10A;

FIG. 12A is a diagram for describing an additional deep learning network according to an embodiment;

FIG. 12B is a diagram for describing an additional deep learning network according to another embodiment;

FIG. 13 is a flowchart for describing a method of obtaining an image, according to an embodiment;

FIG. 14 is a block diagram of a configuration of an electronic apparatus, according to an embodiment;

FIG. 15 is a block diagram of a camera module provided in the electronic apparatus of FIG. 14; and

FIGS. 16 to 25 are diagrams illustrating various examples of an electronic apparatus including an apparatus for obtaining an image, according to various embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. Also, some terms may be arbitrarily selected, and in this case, the meaning of the selected terms will be described in detail in the detailed description of relevant embodiments. Thus, the terms used herein should not be defined simply as the names of the terms, but should be defined based on the meaning of the terms together with the description throughout the embodiments.

In the descriptions of the embodiments, when a component is connected to another component, the component may not only be directly connected to the other component, but may also be electrically connected to the other component with another component in between. The singular forms “a,” “an,” and “the” as used herein are intended to include the plural forms as well unless the context clearly indicates otherwise. Also, it will be understood that when a portion is referred to as “including” another component, it may not exclude the other component but may further include the other component unless otherwise described.

The terms such as “comprise” or “include” used in the present embodiments should not be construed as necessarily including all of various components or operations described herein, and should be construed as meaning that some of the components or operations may not be included or additional components or operations may be further included.

In addition, the terms including ordinal numbers such as “first” or “second” used herein may be used to describe various components, but the components should not be limited by the terms. These terms may be used only to distinguish one component from another.

The description of the following embodiments should not be construed as limiting the scope of rights, and information that can be easily inferred by those of ordinary skill should be construed as falling within the scope of rights of the embodiments. Hereinafter, embodiments for illustrative purposes only will be described in detail with reference to the accompanying drawings.

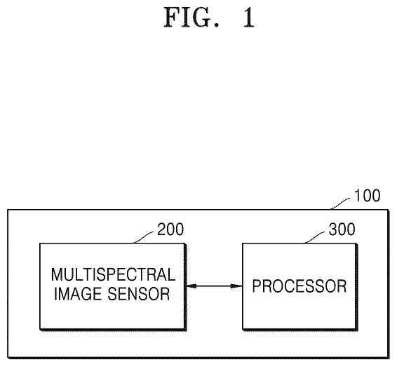

FIG. 1 is a block diagram of an apparatus 100 for obtaining an image according to an embodiment. Referring to FIG. 1, the apparatus 100 according to an embodiment may include a multispectral image sensor 200 and a processor 300. The apparatus 100 is shown as including only components related to the present embodiments, but is not limited thereto. According to the design of the apparatus 100, it may be understood by those of ordinary skill in the art related to the present embodiments that some of the components shown in FIG. 1 may be omitted or new components (e.g., a memory) may be further included. Hereinafter, the operation of each component included in the apparatus 100 will be described without limiting the space where each component is located.

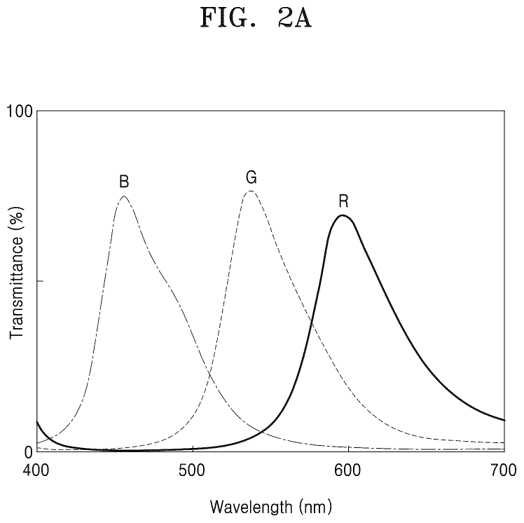

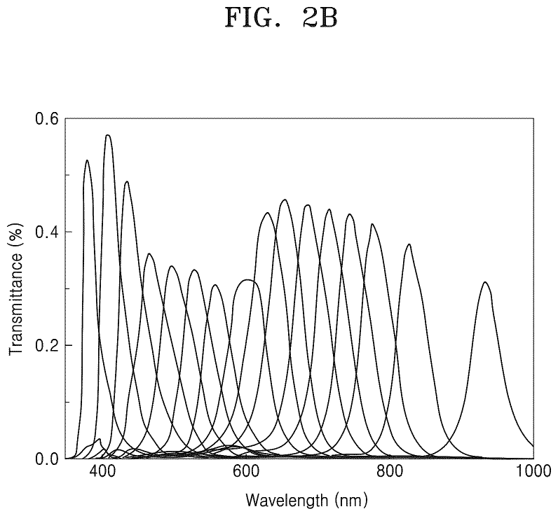

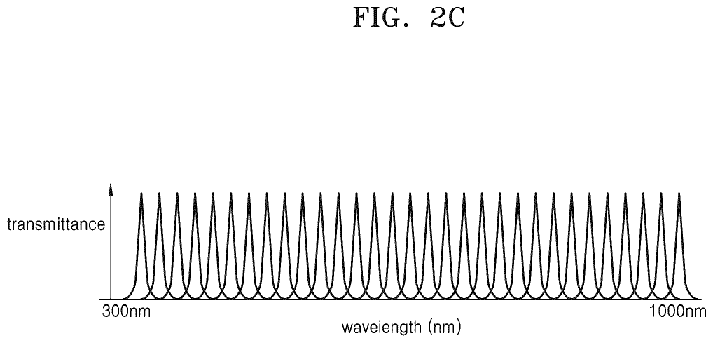

The multispectral image sensor 200 may sense light in various types of wavelength bands. For example, the multispectral image sensor 200 may sense light in more types of wavelength bands than a red-green-blue (RGB) sensor. Referring to FIG. 2A, the RGB sensor may include an R channel, a G channel, and a B channel, and the RGB sensor may sense light in wavelength bands respectively corresponding to the three channels. Unlike FIG. 2A, referring to FIGS. 2B and 2C, the multispectral image sensor 200 may include 16 channels or 31 channels. However, the number of channels included in the multispectral image sensor 200 is not limited thereto, and the multispectral image sensor 200 may include any number of channels, four or more.

The multispectral image sensor 200 may adjust a central wavelength, bandwidth, and transmission amount of light absorbed through each channel. For example, a bandwidth of each channel of the multispectral image sensor 200 may be set to be less than the bandwidths of the R channel, the G channel, and the B channel. As another example, the entire bandwidth (i.e., a sum of the bandwidths of all channels) of the multispectral image sensor 200 may include and may be set to be greater than the entire bandwidth of the RGB sensor. Also, as another example, an image obtained by the multispectral image sensor 200 may be a multispectral or hyperspectral image. The multispectral image sensor 200 may obtain an image by dividing wavelength bands including a visible light band, an infrared band, and an ultraviolet light band into a plurality of bands through a plurality of channels. The multispectral image sensor 200 may obtain an image by using all available channels but may also obtain an image by selecting a particular channel.

The processor 300 controls the overall operations of the apparatus 100. The processor 300 may include one processor core (e.g., a single core) or may include a plurality of processor cores (e.g., a multi-core). The processor 300 may process or execute programs and/or data stored in a memory. For example, the processor 300 may control the functions of the apparatus 100 by executing the programs stored in the memory.

The apparatus 100 may further include a memory. The memory is hardware storing various types of data processed within the apparatus 100. For example, the memory may store images obtained from the multispectral image sensor 200. The memory may be a line memory sequentially storing images in line units or may be a frame buffer storing the entire image. Also, the memory may store applications, drivers, etc. to be driven by the apparatus 100. The memory may include random access memory (RAM) such as dynamic RAM (DRAM) or static RAM (SRAM), read-only memory (ROM), electrically erasable programmable ROM (EEPORM), a compact disc (CD)-ROM, Blu-Ray, another optical disk storage, a hard disk drive (HDD), a solid-state driver (SSD), or flash memory. However, the disclosure is not limited thereto.

The memory may be located outside the multispectral image sensor 200 or may be integrated inside the multispectral image sensor 200. When the memory is integrated inside the multispectral image sensor 200, the memory may be integrated together with a circuit portion. A pixel portion and other portions (i.e., a circuit portion and a memory) may each be integrated into one stack and may thus form a total of two stacks. In this case, the multispectral image sensor 200 may be formed as one chip including two stacks. However, embodiments are not limited thereto. The multispectral image sensor 200 may also be implemented as a three-stack having three layers including a pixel portion, a circuit portion, and a memory.

In addition, the circuit portion included in the multispectral image sensor 200 may be the same as or different from the processor 300. When the circuit portion included in the multispectral image sensor 200 is the same as the processor 300, the apparatus 100 may be the multispectral image sensor 200 itself, which is implemented as an on-chip. Also, even though the circuit portion included in the multispectral image sensor 200 is different from the processor 300, when the processor 300 is arranged inside the multispectral image sensor 200, the apparatus 100 may be implemented as an on-chip. However, the disclosure is not limited thereto. The processor 300 may be separately located outside the multispectral image sensor 200.

The processor 300 may obtain channel signals that are output signals respectively corresponding to channels of the multispectral image sensor 200. The processor 300 may select at least some channels from among a certain number of channels physically provided in the multispectral image sensor 200 and obtain channel signals from the selected channels. For example, the processor 300 may obtain channel signals from all of the certain number of channels physically provided in the multispectral image sensor 200. Also, the processor 300 may obtain channel signals by selecting only some channels from among the certain number of channels physically provided in the multispectral image sensor 200.

The processor 300 may also obtain an increased or decreased number of channel signals than the certain number of channel signals, by synthesizing or interpolating channel signals obtained from the certain number of channels physically provided in the multispectral image sensor 200. For example, the processor 300 may obtain a decreased number of channel signals than the certain number of channel signals, by performing binning for pixels or channels of the multispectral image sensor 200. Also, the processor 300 may obtain an increased number of channel signals than the certain number of channel signals, by generating new channel signals through interpolation of channel signals.

When the number of obtained channel signals decreases, each of the channel signals may correspond to a wide band such that sensitivity of each channel signal may increase and noise may decrease. In contrast, when the number of obtained channel signals increases, sensitivity of each of the channel signals may decrease to a certain degree, but more precise images may be obtained based on the plurality of channel signals. Accordingly, because there is a trade-off according to the increase or decrease in the number of obtained channel signals, the processor 300 may obtain an appropriate number of channel signals according to the application.

The processor 300 may perform image pre-processing or post-processing before or after an image or signal obtained by the multispectral image sensor 200 are stored in the memory. The image pre-processing and post-processing may include bad pixel correction, fixed pattern noise correction, crosstalk reduction, remosaicing, demosaicing, false color reduction, denoising, chromatic aberration correction, or the like.

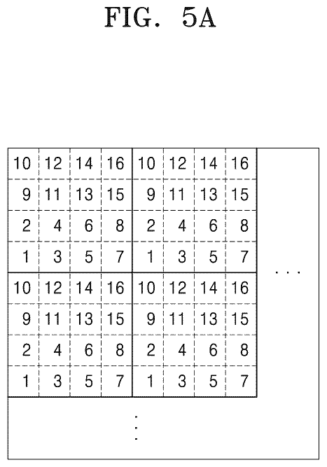

The processor 300 may generate a channel-wise image by demosaicing channel signals and perform image processing for the channel-wise image. Referring to FIGS. 5A and 5B, a raw image obtained from the multispectral image sensor 200 is shown in FIG. 5A, and an image for each channel after demosaicing is shown in FIG. 5B. In the raw image, one small square represents one pixel, and a number within the square represents a channel number. As identified from the channel number, the raw image may be an image obtained by the multispectral image sensor 200 including 16 channels. The raw image includes all pixels corresponding to different channels, but as pixels of the same channel are collected through demosaicing, the channel-wise image may be generated.

The processor 300 may estimate illumination information by inputting, to a pre-trained deep learning network, an image obtained from the multispectral image sensor 200 through four or more channels. As used herein, the illumination information may refer to information regarding intensities of channel signals obtained from the multispectral image sensor according to the wavelength. The term “deep learning network” may be also referred to as a neural network.

The multispectral image sensor 200 may obtain a multispectral image through four or more channels or obtain a hyperspectral image through nine or more channels. The multispectral image sensor 200 may obtain channel signals by selecting all or some of physically provided channels, and the processor 300 may adjust the number of channel signals to be obtained, by synthesizing or interpolating the obtained channel signals.

For example, the multispectral image sensor 200 may obtain a raw image (e.g., the raw image of FIG. 5A) through channels, and the processor 300 may generate a channel-wise image (e.g., the channel-wise image of FIG. 5B) by demosaicing the obtained raw image. The processor 300 may estimate illumination information by inputting the generated channel-wise image to the deep learning network. The multispectral image sensor 200 may generate a number of channel-wise images that is equal to the number of channels, and each channel-wise image may represent data from a specific channel.

The processor 300 may input all or part of the obtained image to the deep learning network. The processor 300 may perform scaling that adjusts the size of the obtained image, and the processor 300 may input both an unscaled image and a scaled image to the deep learning network. However, the disclosure is not limited thereto. The processor 300 may also input, to the deep learning network, an image on which another transformation has been performed.

As the image obtained by the multispectral image sensor 200 is input to the deep learning network, the deep learning network may estimate illumination information regarding the obtained image. The deep learning network may be trained in advance by using a supervised learning method. For example, the deep learning network may be trained by using illumination information, ground truth illumination information, and loss function, which are estimated for each of the images input to the deep learning network. The deep learning network may be pre-trained based on a channel correlation between channels corresponding to the obtained image. As used herein, the channel correlation may refer to information regarding importance of each channel and/or relevance between channels corresponding to the image obtained by the multispectral image sensor 200.

The image obtained by the multispectral image sensor 200 may be expressed as a product of a value representing an illumination source present when the image was captured, as a function and a value representing surface reflectance of an object as a function of a spectrum. The stronger the intensity of an illumination source incident on a channel, the greater the magnitude of a signal obtained through the channel may be. Based on the magnitude of a signal obtained for each channel, information regarding importance of each channel and relevance between channels may be determined.

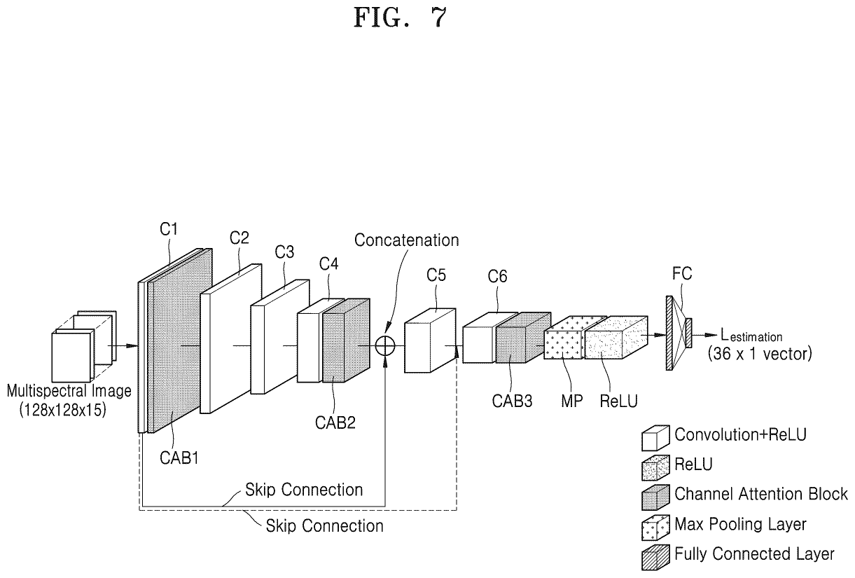

The deep learning network that is trained based on the channel correlation may more accurately estimate illumination information by assigning different weights to respective signals obtained for channels according to the channel correlation between channels corresponding to an image input to the deep learning network. The structure and learning method of the deep learning network that is pre-trained on the channel correlation will be described in detail below in FIG. 7.

The processor 300 may output illumination information estimated by the deep learning network in the form of a vector. The processor 300 may output the illumination information estimated by the deep learning network as an illumination vector corresponding to the estimated illumination information. As used herein, the illumination vector may refer to a vector that constructs the magnitude of a channel signal corresponding to each channel as vector elements. However, the processor 300 may also convert the illumination vector into another vector form and output the illumination vector. For example, the processor 300 may convert the illumination vector into a three-dimensional (3D) vector that constructs an XYZ value in an XYZ color space as vector elements and output the 3D vector, or may convert the illumination vector into a 3D vector that constructs an RGB value in an RGB color space as vector elements and output the 3D vector. However, the disclosure is not limited thereto. The processor 300 may also output the illumination vector as a vector that constructs a color temperature value corresponding to the illumination information as vector elements or a vector that constructs an index value representing a predefined illumination type as vector elements.

The dimension of the illumination vector output by the processor 300 may be equal to the number of channels corresponding to the image input to the deep learning network. For example, the processor 300 may output, as a 16-dimensional illumination vector, illumination information estimated by inputting, to the deep learning network, an image obtained from the multispectral image sensor 200 through 16 channels. However, the disclosure is not limited thereto. The processor 300 may adjust the dimension of the illumination vector to be greater than the number of channels corresponding to the image obtained by the multispectral image sensor 200, and the processor 300 may also adjust the dimension of the illumination vector to 3.

The processor 300 may perform color transformation for the image obtained by the multispectral image sensor 200 based on the estimated illumination information. For example, the processor 300 may perform color transformation on the image obtained by the multispectral image sensor 200, by transforming each element of the illumination vector corresponding to the estimated illumination information into the XYZ color space by using a color matching function. As used herein, the color space may mean that colors recognized by the eyes of humans are expressed on spatial coordinates, and the color transformation may refer to transforming channel signals, which are recorded on an image sensor after passing through a color filter at each pixel, into signals corresponding to the color space.

The processor 300 may perform auto white balance for the image obtained by the multispectral image sensor 200 based on the estimated illumination information. The color of the image obtained by the multispectral image sensor 200 may vary according to an illumination source present in an environment where the image was captured. For example, when white paper is captured in an environment where an illumination source (e.g., an artificial light source such as incandescent, fluorescent, or LED light) is present, the color of the paper may not be expressed as white in the image obtained by the multispectral image sensor 200. As used herein, the auto white balance may refer to a correction method that eliminates a phenomenon in which the color of an image varies according to the illumination source and allows a unique color of an object to be expressed as much as possible in the obtained image.

However, an object for which the processor 300 performs color transformation and/or auto white balance based on the estimated illumination information is not limited to the image obtained by the multispectral image sensor 200. The processor 300 may perform color transformation and/or auto white balance for an image obtained by another image sensor based on the estimated illumination information. For example, an image sensor or the like provided in a main camera of a smartphone may be used as another image sensor that obtains images.

For example, the apparatus 100 may simultaneously obtain images of the same object by using the multispectral image sensor 200 or an RGB sensor in an environment where the same illumination source is present. The processor 300 may obtain illumination information (hereinafter referred to as hyper illumination information) estimated by inputting the image obtained by the multispectral image sensor 200 to the deep learning network, and may simultaneously obtain illumination information (hereinafter referred to as RGB illumination information) estimated by inputting an image obtained by the RGB sensor to the deep learning network.

The processor 300 may perform auto white balance on the image obtained by the RGB sensor, by transforming each element of a hyper illumination vector corresponding to the hyper illumination information into an XYZ value in the XYZ color space and then dividing each element of an RGB illumination vector corresponding to the RGB illumination information by each element of the illumination vector transformed into the XYZ value.

Hereinafter, prior to explaining the deep learning network for estimating illumination information, components of the multispectral image sensor 200 will be described first.

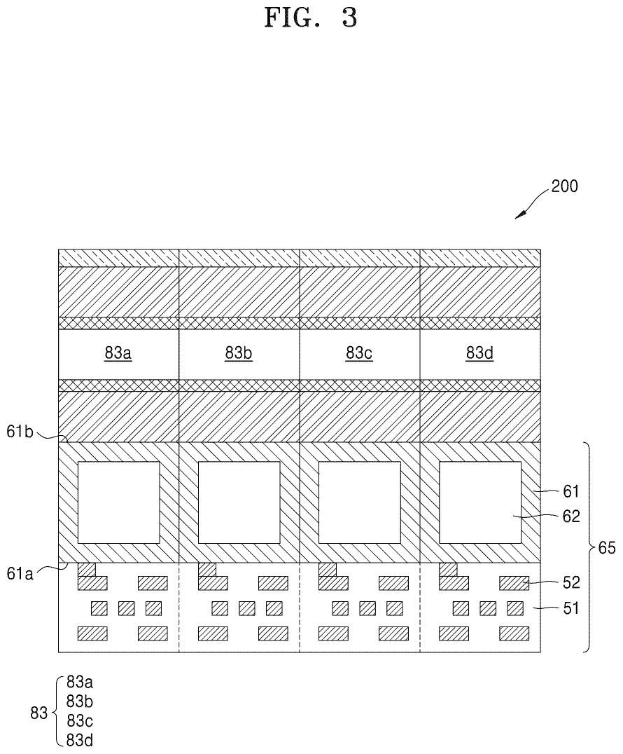

FIG. 3 is a cross-sectional view of the multispectral image sensor 200 according to an embodiment.

For example, the multispectral image sensor 200 shown in FIG. 3 may include a complementary metal oxide semiconductor (CMOS) image sensor or a charge coupled device (CCD) image sensor.

Referring to FIG. 3, the multispectral image sensor 200 may include a pixel array 65 and a spectral filter 83 provided on the pixel array 65. In this case, the pixel array 65 may include a plurality of pixels arranged in two dimensions, and the spectral filter 83 may include a plurality of resonators 83a, 83b, 83c, and 83d provided to correspond to the plurality of pixels. FIG. 3 shows a case where the pixel array 65 includes four pixels and the spectral filter 83 includes four resonators.

Each pixel of the pixel array 65 may include a photodiode 62, which is a photoelectric conversion element, and a driving circuit 52 for driving the photodiode 62. The photodiode 62 may be provided to be buried in a semiconductor substrate 61. For example, a silicon substrate may be used as the semiconductor substrate 61. However, the disclosure is not limited thereto. A wiring layer 51 may be provided on a lower surface 61a of the semiconductor substrate 61, and the driving circuit 52, such as a metal-oxide-semiconductor field-effect transistor (MOSFET), may be provided inside the wiring layer 51.

The spectral filter 83 including the plurality of resonators 83a, 83b, 83c, and 83d may be provided on an upper surface 61b of the semiconductor substrate 61. Each of the resonators may be provided to transmit light in a specific desired wavelength region. Each of the resonators may include reflective layers provided to be spaced apart from each other, and a cavity between the reflective layers. Each of the reflective layers may include, for example, a metal reflective layer or a Bragg reflective layer. Each cavity may be provided to resonate light in a specific desired wavelength region.

The spectral filter 83 may include one or more functional layers that improve the transmittance of light passing through the spectral filter 83 and incident toward the photodiode 62. A functional layer may include a dielectric layer or dielectric pattern with an adjusted refractive index. Also, the functional layer may include, for example, an anti-reflective layer, a focusing lens, a color filter, a short-wavelength absorption filter, or a long-wavelength blocking filter. However, this is merely an example.

Hereinafter, the pixel array of the multispectral image sensor 200 will be described in detail.

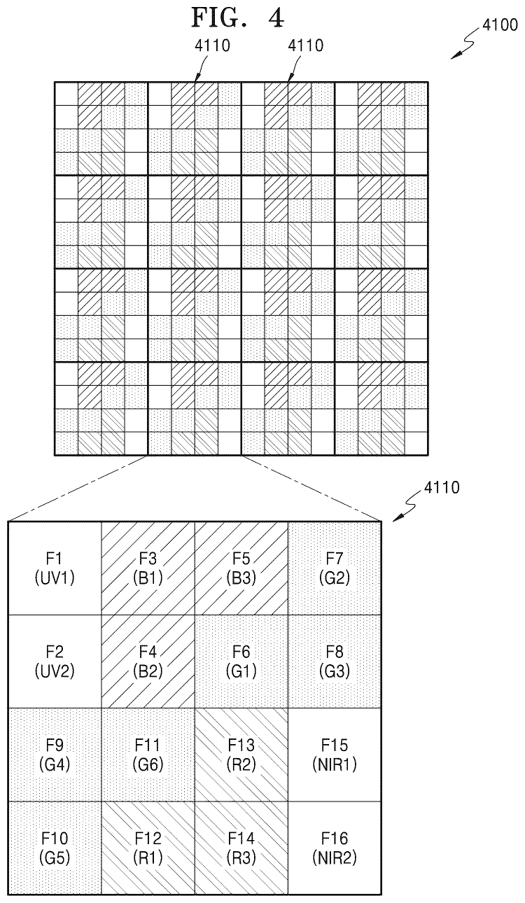

FIG. 4 is a pixel arrangement of a multispectral image sensor, according to an embodiment.

Referring to FIG. 4, a spectral filter 120 provided in a pixel array 4100 may include a plurality of filter groups 4110 arranged in a two-dimensional form. In this case, each filter group 4110 may include 16 unit filters F1 to F16 arranged in a 4×4 array form. However, the disclosure is not limited thereto. For example, each filter group 4110 may include nine unit filters F1 to F9 arranged in a 3×3 array form, each filter group 4110 may include 25 unit filters F1 to F25 arranged in a 5×5 array form, or each filter group 4110 may include M×N unit filters arranged in an M×N (where M and N represent arbitrary integers greater than or equal to 1) array form.

According to an example, when each filter group 4110 is arranged in a 4×4 array form, the first and second unit filters F1 and F2 may have center wavelengths UV1 and UV2 in an ultraviolet region, respectively, and the third to fifth unit filters F3 to F5 may have center wavelengths B1 to B3 in a blue light region, respectively. The sixth to eleventh unit filters F6 to F11 may have center wavelengths G1 to G6 in a green light region, respectively, and the twelfth to fourteenth unit filters may have center wavelengths R1 to R3 in a red light region, respectively. In addition, the fifteenth and sixteenth unit filters F15 and F16 may have center wavelengths NIR1 and NIR2 in a near-infrared region, respectively.

According to another example, when each filter group 4110 is arranged in a 3×3 array form, the first and second unit filters F1 and F2 may have center wavelengths UV1 and UV2 in the ultraviolet region, respectively, and the fourth, fifth, and seventh filters F4, F5, and F7 may have center wavelengths B1 to B3 in the blue light region, respectively. The third and sixth unit filters F3 and F6 may have center wavelengths G1 and G2 in the green light region, respectively, and the eighth and ninth unit filters F8 and F9 may have center wavelengths R1 and R2 in the red light region, respectively.

Also, according to another example, when each filter group 4110 is arranged in a 5×5 array form, the first to third unit filters F1 to F3 may have center wavelengths UV1 to UV3 in the ultraviolet region, respectively, and the sixth, seventh, eighth, eleventh, and twelfth unit filters F6, F7, F8, F11, and F12 may have center wavelengths B1 to B5 in the blue light region, respectively. The fourth, fifth, and ninth unit filters F4, F5, and F9 may have center wavelengths G1 to G3 in the green light region, respectively, and the tenth, thirteenth, fourteenth, fifteenth, eighteenth, and nineteenth unit filters F10, F13, F14, F15, F18, and F19 may have center wavelengths R1 to R6 in the red light region, respectively. In addition, the twelfth, twenty-third, twenty-fourth, and twenty-fifth unit filters F20, F23, F24, and F25 may have center wavelengths NIR1 to NIR4 in the near-infrared region, respectively.

The aforementioned unit filters provided in the spectral filter 120 may have a resonance structure having two reflectors, and a transmission wavelength band may be determined according to characteristics of the resonance structure. The transmission wavelength band may be adjusted according to a material of a reflector, a material of a dielectric material in the cavity, and a thickness of the cavity. In addition, a structure using grating and a structure using a distributed Bragg reflector (DBR) may be applied to the unit filters.

Moreover, pixels of the pixel array 4100 may be arranged in various forms according to color characteristics of the multispectral image sensor 200. Hereinafter, various embodiments of the deep learning network for estimating illumination information for an image obtained from the multispectral image sensor 200 described above will be described.

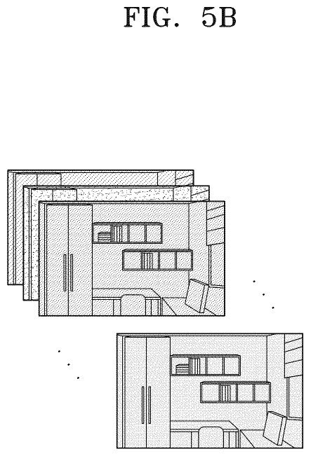

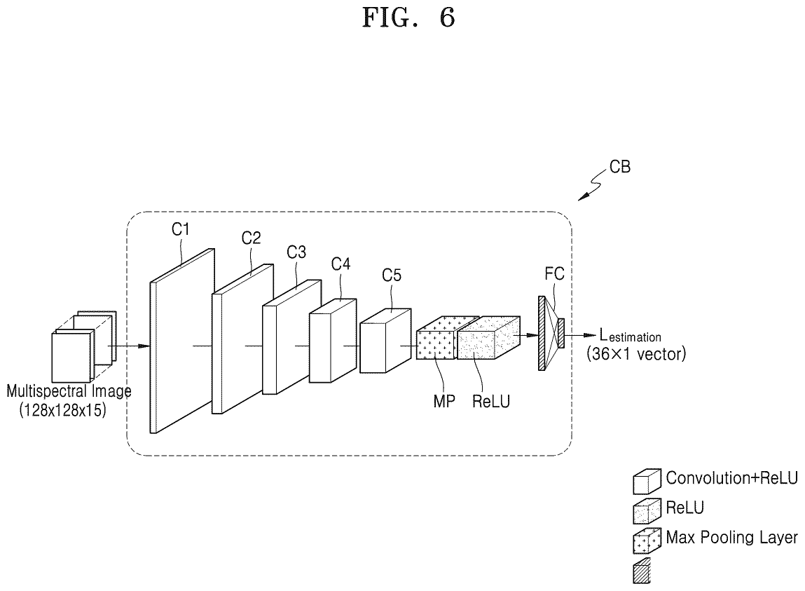

FIG. 6 is a diagram for describing a deep learning network to estimate illumination information, according to an embodiment;

According to an embodiment, the deep learning network of FIG. 6 is used for estimating illumination information for the image obtained from the multispectral image sensor 200 described with reference to FIGS. 1 to 5 in the apparatus 100 described with reference to FIGS. 1 to 5. Accordingly, the descriptions of the apparatus 100 made above with reference to FIGS. 1 to 5 may also apply to the deep learning network of FIG. 6.

Referring to FIG. 6, the deep learning network including a convolution block CB may receive an image obtained from the multispectral image sensor 200 and estimate illumination information for the obtained image. The convolution block CB as used herein may refer to a neural network including one or more convolution layers. For example, the convolution block CB may include five convolution layers C1, C2, C3, C4, and C5, a max pooling layer MP, a rectified linear unit (ReLU) function ReLU, and a fully connected layer FC. The convolution layers C1, C2, C3, C4, and C5 may each further include a ReLU function ReLU as an activation function. However, the aforementioned convolution block CB is merely an embodiment and may be variously configured according to the design of the deep learning network.

The processor 300 may input an image obtained by the multispectral image sensor 200 to the deep learning network including the convolution block CB. That is, the image obtained by the multispectral image sensor 200 may be input to the deep learning network and input to a first layer (e.g., the first convolution layer C1 of FIG. 6) of the deep learning network. An input feature map, which is an image input to the deep learning network including the convolution block CB, may be sequentially input to the plurality of convolution layers C1, C2, C3, C4, and C5 to perform a convolution operation. When an output feature map, which is a result of the convolution operation, is input to the max pooling layer MP, the deep learning network may perform pooling on a global or local region of the output feature map and output a maximum value of a target region on which pooling has been performed. The deep learning network may estimate illumination information for the image obtained by the multispectral image sensor 200, by applying, as an activation function, the ReLU function ReLU to a result output from the max pooling layer MP.

The deep learning network may adjust the dimension of an output vector corresponding to the estimated illumination information by using the fully connected layer FC. For example, the number Cₒ of output nodes of the fully connected layer FC may be set to be equal to the number Cᵢ of channels corresponding to the image input to the deep learning network or may be set to 3. However, the disclosure is not limited thereto. The number Cₒ of output nodes of the fully connected layer FC may also be determined by a preset relational equation with respect to the number C, of channels corresponding to the image input to the deep learning network. The following shows relational equations regarding the number Cₒ of output nodes and the number Cₗ of channels corresponding to the image input to the deep learning network.

$${C}_{o} = k * {C}_{i} \qquad [ Equation 1 ]$$

$${C}_{o} = k * ( {C}_{i} - a ) + b ) \qquad [ Equation 2 ]$$

In Equation 1 and Equation 2, k may be determined as the power of an exponent of 2, such as 1, 2, 4, . . . , and in Equation 2, a may refer to the number of channels that are not input to the deep learning network among channels corresponding to the image obtained by the multispectral image sensor 200, and b may refer to the number of channels output from an additionally generated deep learning network.

An apparatus for obtaining an image according to an embodiment may more accurately estimate illumination information by adjusting the dimension of an illumination vector corresponding to the illumination information estimated from the deep learning network to be greater than the number of channels corresponding to the image input to the deep learning network. Accordingly, the apparatus may perform auto white balance more effectively for the image obtained from the multispectral image sensor 200.

Hereinafter, the structure and learning method of the deep learning network that is pre-trained on a channel correlation as a deep learning network for estimating illumination information for the image obtained from the multispectral image sensor 200 will be described.

FIG. 7 is a diagram for describing a deep learning network to estimate illumination information, according to another embodiment. The deep learning network of FIG. 7 may differ from the deep learning network of FIG. 6 only in that a channel attention block CAB is added to the deep learning network, and redundant descriptions thereof will be omitted below.

Referring to FIG. 7, the deep learning network including the channel attention block CAB may receive an image obtained from the multispectral image sensor 200 and estimate illumination information for the obtained image. The channel attention block CAB as used herein may refer to a neural network for learning a channel correlation between channels corresponding to the image input to the deep learning network.

The channel attention block CAB may follow at least one convolution layer among the convolution layers C1, C2, C3, C4, and C5 and may input, to the convolution layer, information regarding intensities of channel signals corresponding to an image input to the channel attention block CAB.

The channel attention block CAB may be located subsequent to a first layer (e.g., the first convolution layer C1) of the deep learning network and may input, to the first layer, information regarding intensities of channel signals corresponding to the image obtained from the multispectral image sensor 200. For example, a first channel attention block CAB1 may be located subsequent to the first convolution layer C1 and may input, to the first convolution layer C1, information regarding intensities of channel signals corresponding to the image input to the first channel attention block CAB1.

However, the disclosure is not limited thereto. The channel attention block CAB may be located subsequent to an intermediate layer (e.g., the fourth convolution layer C4 or the sixth convolution layer C6) following the first layer of the deep learning network and may input, into the intermediate layer, information regarding intensities of channel signals corresponding to an intermediate image output from a layer (e.g., the third convolution layer C3 or the fifth convolution layer C5) preceding the intermediate layer. For example, a second channel attention block CAB2 may be located subsequent to the fourth convolution layer C4 and may input, to the fourth convolution layer C4, information regarding intensities of channel signals corresponding to an image input to the second channel attention block CAB2, and a third channel attention block CAB3 may be located subsequent to the sixth convolution layer C6 and may input, to the sixth convolution layer C6, information regarding intensities of channel signals corresponding to an image input to the third channel attention block CAB3.

Because the apparatus according to an embodiment may be trained based on a channel correlation between channels corresponding to the image obtained from the multispectral image sensor 200 by using the deep learning network including the channel attention block CAB, illumination information for the image obtained from the multispectral image sensor 200 may be estimated more accurately.

The deep learning network including the channel attention block CAB may be trained by using supervised learning. For example, the deep learning network including the channel attention block CAB may optimize parameters of the deep learning network by using a backpropagation algorithm. The deep learning network including the channel attention block CAB may be trained by sequentially updating an output of the deep learning network and a weight of a hidden layer in an opposite direction to a processing direction of the deep learning network in proportional to an error between ground truth illumination information L_{GT} and estimation illumination information Lₑₛₜ. As used herein, the ground truth illumination information L_{GT} may refer to illumination information that is a true value corresponding to a training image for training the deep learning network, and the estimation illumination information Lₑₛₜ may refer to illumination information estimated by inputting a training image to the deep learning network.

The deep learning network including the channel attention block CAB may be trained by using a loss function including an angular error (AE). Each AE is a measure of an angle between vectors, and only a difference in relative orientation between vectors may be considered, not the size of a vector itself. Because illumination information estimated by the deep learning network is information regarding intensities of channel signals obtained from an image sensor, it may be important for the deep learning network to learn a relative difference in intensity of channel signals for each channel. As the deep learning network is trained by using a backpropagation algorithm for an AE, learning efficiency may be improved, and the apparatus including the deep learning network may more accurately estimate illumination information for the image obtained from the multispectral image sensor 200.

The deep learning network including the channel attention block CAB may be trained by using a hyper AE AE_{hyper} and an XYZ AE AE_{XYZ}. For example, as shown in Equation 3 below, the deep learning network may weighted-sum the hyper AE AE_{hyper} and the XYZ AE AE_{XYZ} in a certain ratio and use the weighted sum as a loss function.

$$ℓ = α {AE}_{hyper} + ( 1 - α ) {AE}_{XYZ} \qquad [ Equation 3 ]$$

In Equation 3, [symbol] refers to a loss function, and a is an experimentally [symbol] defined value.

The hyper AE AE_{hyper} refers to an angle between hyper ground truth illumination information L_{GT_hyper} and hyper estimation illumination information L_{est_hyper}, and the XYZ AE AE_{XYZ} refers to an angle between XYZ ground truth illumination information L_{GT_hyper} and XYZ estimation illumination information L_{est_hyper}. The hyper AE AE_{hyper} and the XYZ AE AE_{XYZ} may be determined by Equation 4 and Equation 5 below, respectively.

$${AE}_{hyper} = a cos ( \frac{{L}_{GT \_ hyper} \cdot {L}_{est\_hyper}}{{‖ {L}_{GT \_ hyper} ‖}_{2} \cdot {‖ {L}_{est\_hyper} ‖}_{2}} ) \qquad [ Equation 4 ]$$

$${AE}_{XYZ} = a cos ( \frac{{L}_{GT \_ XYZ} \cdot {L}_{est\_XYZ}}{{‖ {L}_{GT \_ XYZ} ‖}_{2} \cdot {‖ {L}_{est\_XYZ} ‖}_{2}} ) \qquad [ Equation 5 ]$$

As used herein, the hyper AE AE_{hyper} may refer to the angle between the hyper ground truth illumination information L_{GT_hyper} and the hyper estimation illumination information L_{est_hyper}, and the XYZ AE AE_{XYZ} may refer to the angle between the XYZ ground truth illumination information L_{GT_hyper} and the XYZ estimation illumination information L_{est_hyper}.

The hyper ground truth illumination information L_{GT_hyper} is ground truth illumination information L_{GT} related to the multispectral image sensor 200 and may be expressed as an illumination vector that constructs the magnitude of a channel signal, which is a true value corresponding to each channel of the multispectral image sensor 200, as vector elements. The hyper estimation illumination information L_{est_hyper} is estimation illumination information Lₑₛₜ related to the multispectral image sensor 200 and may be expressed as an illumination vector that constructs the magnitude of an estimated channel signal corresponding to each channel of the multispectral image sensor 200 as vector elements.

The XYZ ground truth illumination information L_{GT_hyper} may refer to illumination information obtained by transforming the hyper ground truth illumination information L_{GT_hyper} into an XYZ color space by using a color matching function, and the XYZ estimation illumination information L_{est_hyper} may refer to illumination information obtained by transforming the hyper estimation illumination information L_{est_hyper} into the XYZ color space by using the color matching function.

Because the deep learning network is trained by using both the hyper AE AE_{hyper} and the XYZ AE AE_{XYZ}, illumination information measured by the multispectral image sensor 200, which is higher-dimensional than the illumination information transformed into the XYZ color space, may also be sufficiently learned. Accordingly, the apparatus according to an embodiment may more accurately estimate illumination information for the image obtained from the multispectral image sensor 200, by estimating the illumination information by using the deep learning network that has been trained by using both the hyper AE AE_{hyper} and the XYZ AE AE_{XYZ}.

Also, because the deep learning network is trained by using a loss function that represents the weighted sum of the hyper AE AE_{hyper} and the XYZ AE AE_{XYZ}, the deep learning network may learn or predict the relationship between the illumination information measured by the multispectral image sensor 200 and the illumination information transformed into the XYZ color space. Accordingly, the apparatus according to an embodiment may more accurately estimate the illumination information transformed into the XYZ color space, by estimating the illumination information using the deep learning network that has been trained by weighted-summing the hyper AE AE_{hyper} and the XYZ AE AE_{XYZ} in a certain ratio and using the weighted sum as a loss function.

One or more illumination sources may be present in an environment where an image is captured by the apparatus 100. When the multispectral image sensor 200 captures a mixed illumination image in an environment having two different illumination sources, the apparatus 100 may use the deep learning network including two or more channel attention blocks CAB.

The processor 300 may divide the mixed illumination image obtained by the multispectral image sensor 200 into two or more regions. For example, the processor 300 may divide the mixed illumination image into a region where the first illumination source is dominant and a region where the second illumination source is dominant. As used herein, the expression “region where the first illumination source is dominant” may refer to a region where an intensity of the first illumination source is greater than that of any other illumination sources in an environment by a predetermined threshold amount or more. Hereinafter, the expression may be used with the same meaning.

The processor 300 may estimate illumination information for the first illumination source by using the deep learning network for the region where the first illumination source is dominant in the mixed illumination image, and may estimate illumination information for the second illumination source by using the deep learning network for the region where the second illumination source is dominant in the mixed illumination image. The processor 300 may weighted-sum, in a certain ratio, a first illumination vector corresponding to the illumination information for the first illumination source and a second illumination vector corresponding to the illumination information for the second illumination source. In this case, a weighting coefficient is 0 or more, and a sum of weighting coefficients may be set to 1.

The deep learning network including the channel attention block CAB may include a skip connection for inputting an image, which is input to one convolution layer (e.g., the first convolution layer C1), to another convolution layer (e.g., the fifth convolution layer C5 or the sixth convolution layer C6) following the one convolution layer. For example, the deep learning network may input an image, which is input to one convolution layer (e.g., the first convolution layer C1), to another convolution layer (e.g., the fifth convolution layer C5) following the one convolution layer in units of pixels. As another example, the deep learning network may input an image, which is input to one convolution layer (e.g., the first convolution layer C1), to another convolution layer (e.g., the fifth convolution layer C5) following the one convolution layer in units of channels.

The more an image input to a convolution layer located close to an input terminal of the deep learning network is used for the skip connection, the more accurately the deep learning network may estimate illumination information for an image input to the deep learning network. For example, an image input to the first convolution layer C1 may be the image itself input to the deep learning network. In contrast, an image input to the second convolution layer C2 may be an intermediate image output from the first convolution layer C1 after the image input to the deep learning network is input to the first convolution layer C1. Accordingly, the image input to the first convolution layer C1 may include more pieces of microscopic information, such as boundary lines and color information, than the image input to the second convolution layer C2. The apparatus 100 according to the present embodiment uses the deep learning network including the skip connection and may thus more accurately estimate illumination information for the image obtained by the multispectral image sensor 200.

Hereinafter, the structure of the channel attention block will be described in more detail.

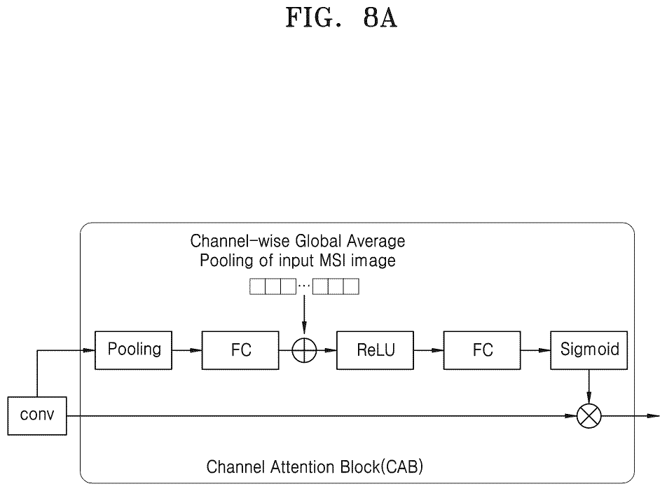

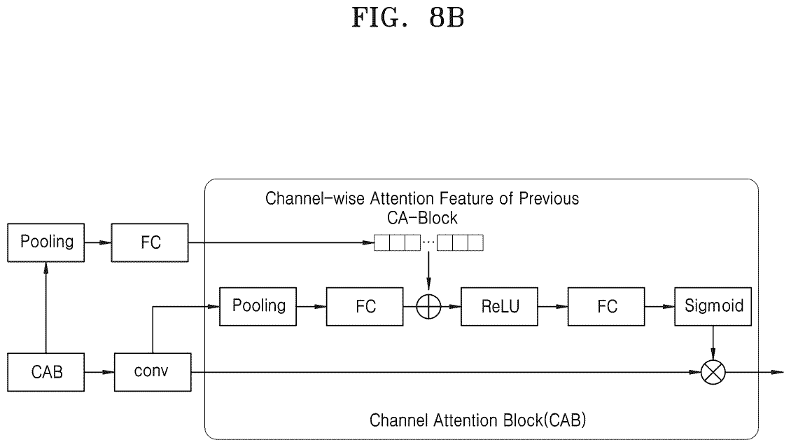

FIG. 8A is a diagram for describing the channel attention block of FIG. 7, according to an embodiment.

Referring to FIG. 8A, the channel attention block CAB may be located subsequent to a convolution layer conv, and an output feature map output from the convolution layer conv may be input to the channel attention block CAB.

The channel attention block CAB may include a pooling layer and a first fully connected layer.

The output feature map, which is a result of a convolution operation and output from the convolution layer conv, may be input to the pooling layer, and accordingly, the deep learning network may perform max pooling or average pooling on a global or local region of the output feature map and output a maximum value or an average value of a target region on which pooling has been performed.

The deep learning network may use the first fully connected layer to adjust the number of channels corresponding to a result output from a max pooling layer to be equal to the number of channels corresponding to the image input to the deep learning network including the channel attention block CAB.

The processor may perform global max pooling or global average pooling on the image obtained from the multispectral image sensor 200 and generate a first channel vector that constructs a maximum value or an average value of a global region of the image obtained from the multispectral image sensor 200 as vector elements. The pooling operation for obtaining the first channel vector may be performed with or without using a machine learning model. When the deep learning network obtain the first channel vector, the deep learning network may add the first channel vector to an output result of the first fully connected layer of the channel attention block CAB and then apply an ReLU activation function to the combined output, which is achieved by adding or concatenating the first channel vector with the output result of the first fully connected layer.

The dimension of the generated first channel vector may be equal to the number of channels corresponding to the image obtained from the multispectral image sensor 200, but is not limited thereto. The dimension of the first channel vector may be adjusted to be greater than the number of channels corresponding to the image obtained from the multispectral image sensor 200. The deep learning network may adjust the dimension of the first channel vector by using the fully connected layer FC. For a method by which the deep learning network adjusts the dimension of a vector by using the fully connected layer FC, a method by which the deep learning network including the convolution block CB adjusts the dimension of the output vector corresponding to the estimated illumination information by using the fully connected layer FC, described with reference to FIG. 6, may be applied as is.

The channel attention block CAB may receive as input, the output feature map output from the convolution layer conv, and the first channel vector generated by performing global max pooling or global average pooling on the image obtained from the multispectral image sensor 200. The channel attention block CAB may assign different weights respectively to signals obtained for each channel according to the first channel vector that represents the channel correlation between the channels of the multispectral image sensor 200 (or the channel correlations between the channel-wise images of the multispectral image sensor 200). Accordingly, the apparatus according to an embodiment may more accurately estimate illumination information for the image obtained from the multispectral image sensor 200.

In particular, as the deep learning network inputs, to the output feature map output from the convolution layer conv, the first channel vector generated by performing global average pooling on the image obtained from the multispectral image sensor 200, the apparatus according to an embodiment may more accurately estimate illumination information for an image captured in an environment where an illumination source with a narrow wavelength band is present.

As another example, the channel attention block CAB may further include a rectified linear unit function, a second fully connected layer, and a sigmoid function. The deep learning network may sequentially apply the rectified linear unit function, the second fully connected layer, and the sigmoid function to an output result in which the generated first channel vector is added (e.g., concatenated) to the output result of the first fully connected layer of the channel attention block CAB, and may perform a convolution operation with the output feature map, which is the result of the convolution operation and output from the convolution layer conv.

FIG. 8B is a diagram for describing the channel attention block CAB of FIG. 7, according to another embodiment. The channel attention block of FIG. 8B may differ from the channel attention block of FIG. 8A only in a channel vector added to the output result of the first fully connected layer, and redundant descriptions thereof will be omitted below.

The convolution layer conv shown in FIG. 8B is a convolution layer located before a convolution layer to which a result output from the channel attention block CAB is input, and may be one of intermediate convolution layers (e.g., the fourth convolution layer C4 and sixth convolution layer C6 of FIG. 6). Hereinafter, the convolution layer conv shown in FIG. 8B will be referred to as an intermediate convolution layer. The processor may perform global max pooling or global average pooling on an intermediate image output from the intermediate convolution layer and generate a second channel vector that constructs a maximum value or an average value of a global or local region of the intermediate image with vector elements.

For example, the deep learning network may add the generated second channel vector to the output result of the first fully connected layer of the channel attention block CAB and then perform a convolution operation with an output feature map, which is a result of a convolution operation and output from the intermediate convolution layer.

The dimension of the generated second channel vector may be equal to the number of channels corresponding to the output feature map output from the intermediate convolution layer, but is not limited thereto. The dimension of the second channel vector may be adjusted to be greater than the number of channels corresponding to the output feature map output from the intermediate convolution layer. The deep learning network may adjust the dimension of the second channel vector by using the fully connected layer FC. For the method by which the deep learning network adjusts the dimension of a vector by using the fully connected layer FC, the method by which the deep learning network including the convolution block CB adjusts the dimension of the output vector corresponding to the estimated illumination information by using the fully connected layer FC, described with reference to FIG. 6, may be applied as is.

As the deep learning network inputs, to the output feature map output from the intermediate convolution layer, the second channel vector generated by performing global max pooling, global average pooling, local max pooling, or local average pooling on the output feature map output from the intermediate convolution layer, the deep learning network may assign different weights respectively to signals obtained for each channel according to the channel correlation between channels corresponding to the image input to the deep learning network. Accordingly, the apparatus according to an embodiment may more accurately estimate illumination information for the image obtained from the multispectral image sensor 200.

In particular, as the deep learning network inputs, to the output feature map output from the intermediate convolution layer, the second channel vector generated by performing global average pooling or local average pooling on the output feature map output from the intermediate convolution layer, the apparatus according to an embodiment may more accurately estimate illumination information for an image captured in an environment where an illumination source with a narrow wavelength band is present.

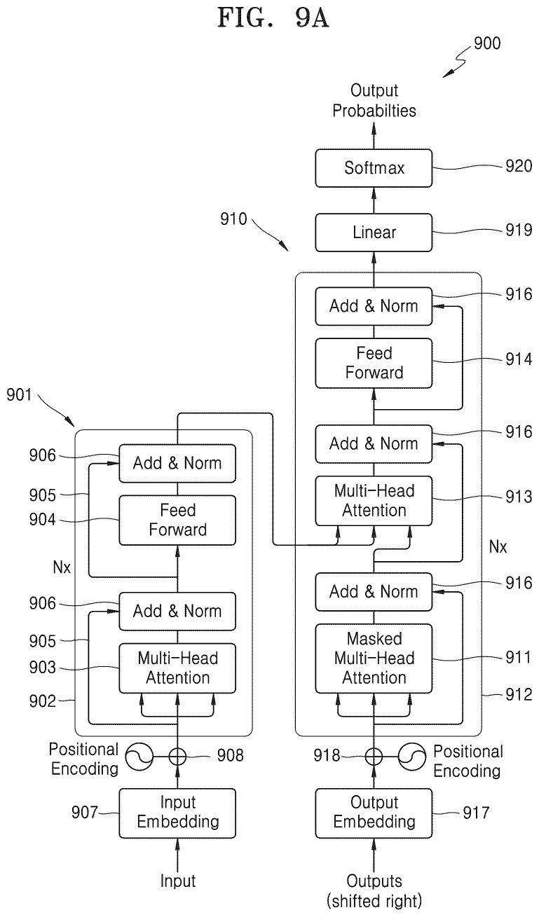

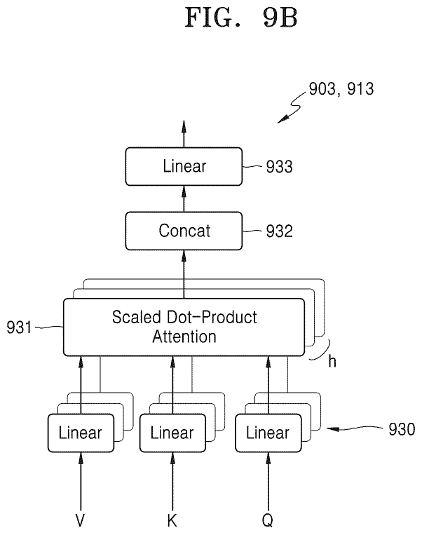

FIG. 9A is a diagram for describing a structure of a transformer 900, according to an embodiment.

Referring to FIG. 9A, the transformer 900 according to an embodiment may include an encoder 901 and a decoder 910. The encoder 901 and/or the decoder 910 may be implemented as one or more modules each including a series of sub-models.

The encoder 901 may include N layers 902, where N is a positive integer. Each layer 902 may be referred to as a sub-model and may include a multi-head attention layer 903 and a feed-forward layer 904. A residual connection 905 may be used on the circumference of each of the multi-head attention layer 903 and the feed-forward layer 904, which are followed by layer normalization 906. An output of the decoder 910 may be embedded in an input embedding 907 and added to embedded representations of inputs of a positional encoding 908.

The decoder 910 may also include N layers 912. Each layer 912 may be referred to as a sub-model and may include a masked multi-head attention layer 911, a multi-head attention layer 913, and a feed-forward layer 914. A residual connection 915 may be used on the circumference of each of the multi-head attention layer 913 and the feed-forward layer 914, which are followed by layer normalization 916. The masked multi-head attention layer 911 may prevent attending to subsequent positions. The output of the decoder 910 may be embedded in an output embedding 917 and may be positionally offset by one position in a positional encoding 918 such that predictions about a position i may only depend on a known output at positions less than i.

The output of the decoder 910 may be an input to a linear classifier layer 919 and an output of the linear classifier layer 919 may be input to a SoftMax layer 920, which provides as output probabilities that may be used to predict a next token in an output sequence. The transformer 900 may include a plurality of row-column multiplication operations that may use dynamically updated weights instead of static weights.

FIG. 9B is a diagram for describing a structure of a multi-head attention layer of FIG. 9A, and FIG. 9C is a diagram illustrating a calculation result of the multi-head attention layer of FIG. 9B.

Referring to FIG. 9B, the multi-head attention layer shown in FIG. 9B may be the multi-head attention layer 903 of the encoder 901 and the multi-head attention layer 913 of the decoder 910 shown in FIG. 9A. The multi-head attention layer may include, when h is a positive integer, h linear projections 930 of matrices V, K, and Q, h scaled dot-product attention layers 931, a concatenation layer 932, and a linear classifier layer 933.

The multi-head attention layer 903 of the encoder 901 and the multi-head attention layer 913 of the decoder 910 may be parallelized with linear projections of V, K, and Q. In this case, V may be a matrix (or feature map) of values of vector representations of all words in a sequence, K may be a matrix (or feature map) of all keys, which are vector representations of all words in a sequence, and Q may be a matrix (or feature map) including a query, which is a vector representation of one word in a sequence. Parallelization may allow the transformer 900 to usefully learn from different representations of V, K, and Q. Linear representations may be formed by multiplying V, K, and Q by a weight matrix W learned by the transformer 900 through training. The matrices V, K and Q may be different for each position of the attention modules in the transformer 900 depending on whether the matrices V, K and Q are in the encoder 901, the decoder 910, or in-between the encoder 901 and decoder 910 so that either the whole or a part of encoder input sequence may be attended. A multi-head attention module that connects the encoder 901 and the decoder 910 to each other may consider the encoder input sequence together with a decoder input sequence up to a given position.

The feed-forward layer 904 of the encoder 901 and the feed-forward layer 914 of the decoder 910 may be arranged on the rear of the multi-head attention layer 903 of the encoder 901 and on the rear of the multi-head attention layer 913 of the decoder 910, respectively. The feed-forward layer 904 of the encoder 901 and the feed-forward layer 914 of the decoder 910 may each include identical parameters for each position to provide separate identical linear transformations for each element from a given sequence.

Referring to FIG. 9C, when attention head #0 is applied, matrices Q₀, K₀, and Vo are multiplied by weight matrices W₀^{Q}, W₀^{K}, and W₀^{V}, respectively. When attention head #1 is applied, matrices Q₁, K₁, and V₁ are multiplied by weight matrices W₁^{Q}, W₁^{K}, and W₁^{V}, respectively

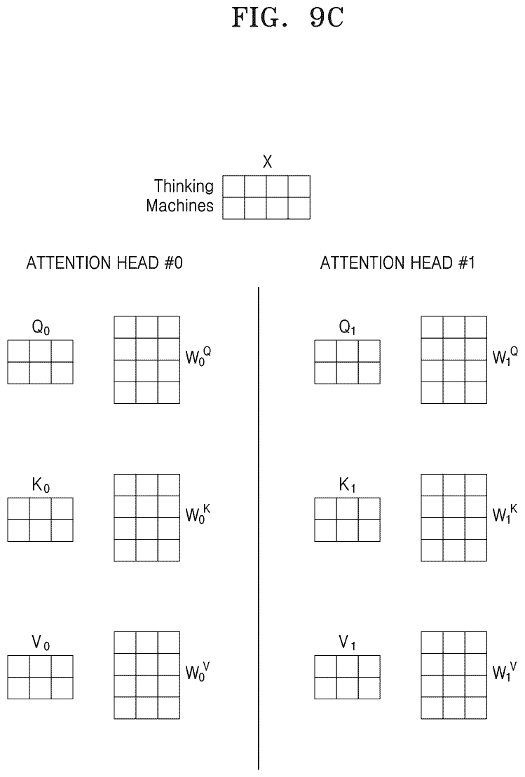

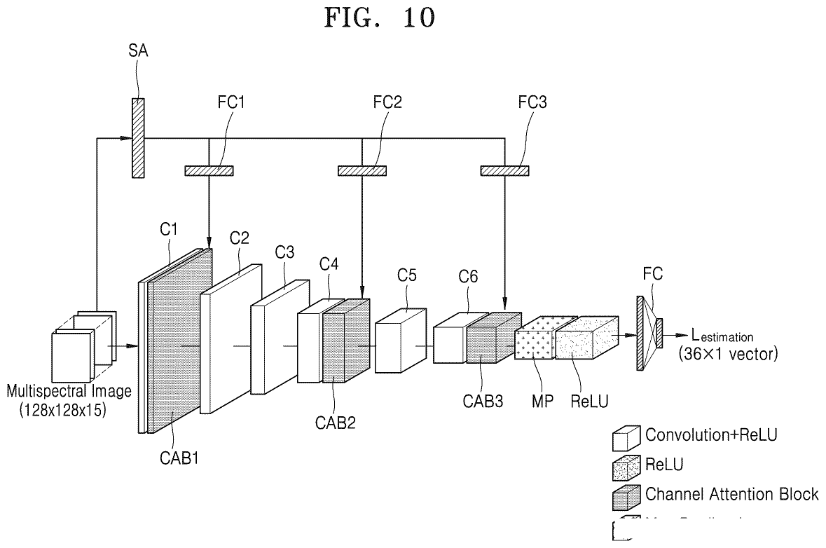

FIG. 10 is a diagram for describing a deep learning network to estimate illumination information, according to another embodiment. The deep learning network of FIG. 10 may differ from the deep learning network of FIG. 7 in that a self-attention layer SA and a fully connected layer FC are added to the deep learning network, and redundant descriptions thereof will be omitted below.

As used herein, the self-attention layer SA is a neural network for learning the channel correlation between channels corresponding to the image input to the deep learning network and may refer to a neural network including some layers of the transformer 900 shown in FIG. 9A.

Referring to FIG. 10, the deep learning network including the self-attention layer SA may receive an image obtained from the multispectral image sensor 200 and estimate illumination information for the obtained image. The processor 300 may input the image obtained by the multispectral image sensor 200 to each of the first convolution layer C1 and the self-attention layer SA. That is, the image obtained by the multispectral image sensor 200 may be input to the deep learning network and input to the first convolution layer C1 and the self-attention layer SA.

The processor 300 may divide the image obtained by the multispectral image sensor 200 and input the divided images to the self-attention layer SA. When the size of an image input to the self-attention layer SA is W×H, the processor 300 may divide the image into images having a size of N×N or divide the image for each channel, and the processor 300 may input the divided images to the self-attention layer SA. When the image divided for each channel is input to the self-attention layer SA, the processor 300 may input all images obtained through channels to the self-attention layer SA or may input only images obtained through some channels to the self-attention layer SA. The processor 300 may individually input each of the images obtained through the channels to the self-attention layer SA or may also group the images obtained through the channels and then input the grouped images to the self-attention layer SA. For example, when the number of channels corresponding to the image input to the deep learning network is Cₗ, the processor 300 may stack and group images obtained through N channels for each channel and input only images obtained through Cᵢ/N channels to the self-attention layer SA. When the processor 300 does not input images obtained through some channels to the self-attention layer SA or when the encoder 901 of the transformer 900 is not included in the self-attention layer SA, the encoder 901 may mask the images obtained through some channels such that the images are not used in a subsequent self-attention process. The processor 300 may adjust the number of channels corresponding to the image input to the self-attention layer SA, by adjusting the number of channel signals to be obtained by synthesizing or interpolating obtained channel signals. The self-attention layer SA according to an example may include the transformer 900 of FIG. 9A. The transformer 900 may input an input image to the multi-head attention layer 903 of the encoder 901 and calculate a key, query, and value for each channel. The transformer 900 may obtain a score function by inputting the calculated key, query, and value to a scaled dot-product attention layer 931. As used herein, the expression score function may refer to the degree of influence that each channel has on a channel for which illumination information is to be obtained. Hereinafter, the expression may be used with the same meaning. The score function may be determined by Equation 6 below.

$$score function ( q , k ) = \frac{q * k}{\sqrt{{d}^{k}}} \qquad [ Equation 6 ]$$

The deep learning network may learn a channel correlation for the image obtained by the multispectral image sensor 200, by multiplying a value corresponding to an image obtained through a specific channel by the score function or multiplying the specific channel itself by the score function and then obtaining an image through the specific channel. The apparatus 100 according to the present embodiment may more accurately estimate illumination information for the image obtained by the multispectral image sensor 200 by using the deep learning network that is pre-trained on the channel correlation. The self-attention layer SA according to another example may include only the encoder 901 of the transformer 900 of FIG. 9A. That is, the self-attention layer SA may include the multi-head attention layer 903 and the feed-forward layer 904 of the encoder 901. The self-attention layer SA according to another example may obtain the score function by inputting an input image to the multi-head attention layer 903 of the encoder 901. The deep learning network may learn the channel correlation for the image obtained by the multispectral image sensor 200, by multiplying the value corresponding to the image obtained through the specific channel by the score function or multiplying the specific channel itself by the score function and then obtaining the image through the specific channel. The apparatus 100 according to the present embodiment may more accurately estimate illumination information for the image obtained by the multispectral image sensor 200, by using the deep learning network that is pre-trained on the channel correlation. Also, the self-attention layer SA according to another example may include a global average pooling layer. After the image input to the deep learning network is input to the global average pooling layer, the self-attention layer SA may learn the channel correlation for the image obtained by the multispectral image sensor 200, by multiplying a result output from an average pooling layer by the score function used in the transformer 900 of FIG. 9A. The apparatus 100 according to the present embodiment may more accurately estimate illumination information for the image obtained by the multispectral image sensor 200, by using the deep learning network that is pre-trained on the channel correlation.

A result output from the self-attention layer SA may be input to each of fully connected layers FC1, FC2, and FC3 and then input to each of the channel attention blocks CAB1, CAB2, and CAB3 of the deep learning network (e.g., the deep learning network in FIG. 7) including the channel attention block CAB. The deep learning network including the self-attention layer SA may more accurately learn the channel correlation by using the self-attention layer SA and the channel attention blocks CAB1, CAB2, and CAB3, and accordingly, the apparatus 100 according to the present embodiment may more accurately estimate illumination information for the image obtained by the multispectral image sensor 200.

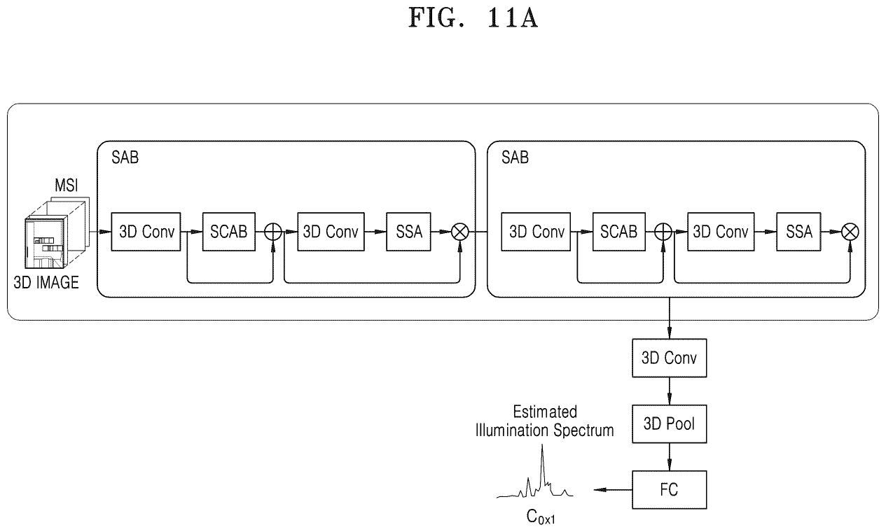

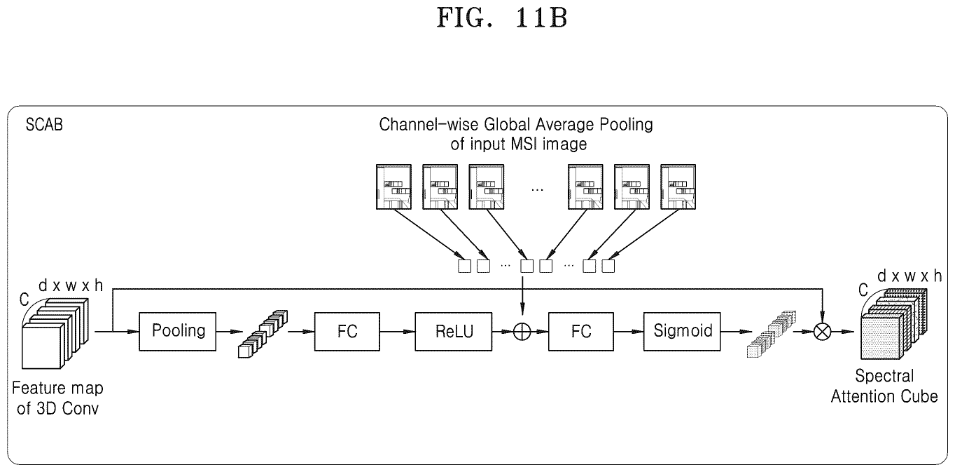

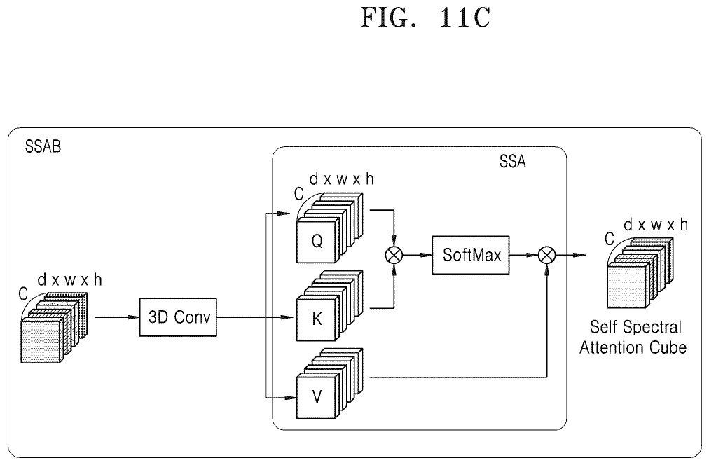

FIG. 11A is a diagram for describing a deep learning network including a 3D convolution layer. FIG. 11B is a diagram for describing a spectral channel attention block of FIG. 11A, and FIG. 11C is a diagram for describing a spectral self-attention block of FIG. 11A.

Referring to FIG. 11A, the deep learning network may include at least one spatial attention block SAB, a 3D convolution layer 3D conv, a 3D pooling layer, and a fully connected layer. As used herein, the spatial attention block SAB may refer to a neural network including a 3D convolution layer 3D conv for performing 3D convolution and a spectral channel attention block SCAB located subsequent to the 3D convolution layer 3D conv. The 3D convolution as used herein refers to performing a convolution operation on three parameters, and the 3D convolution layer 3D conv as used herein may perform a convolution operation based on information regarding a spectral channel and the height and width of a 2D image. In this case, the information regarding a spectral channel may include the size or index of a channel, but is not limited thereto. The deep learning network including the 3D convolution layer 3D conv may more accurately estimate the channel correlation.

The deep learning network including the spectral channel attention block SCAB in FIG. 11B may differ from the deep learning network including the channel attention block CAB in FIG. 7 in that an image input to the spectral channel attention block SCAB of FIG. 11B is different from an image input to the channel attention block CAB of FIG. 7, and redundant descriptions thereof will be omitted below. That is, the spectral channel attention block SCAB of FIG. 11B may differ from the channel attention block CAB of FIG. 7 in that the spectral channel attention block SCAB of FIG. 11B is located subsequent to the 3D convolution layer 3D conv, whereas the channel attention block CAB of FIG. 7 is located subsequent to the convolution layer conv.

Because the deep learning network including the 3D convolution layer 3D conv and the spectral channel attention block SCAB is pre-trained on the channel correlation between channels corresponding to the image obtained by the multispectral image sensor 200, the apparatus 100 according to the present embodiment may more accurately estimate illumination information for the image obtained from the multispectral image sensor 200.

The spatial attention block SAB of FIG. 11A may further include a spectral self-attention block SSAB, and the spectral self-attention block SSAB may include a 3D convolution layer 3D conv and a spectral self-attention layer SSA located subsequent to the 3D convolution layer 3D conv. An output feature cube output from the 3D convolution layer 3D conv may be input to the spectral self-attention layer SSA to calculate a query Q, a key K, and a value V. The spectral self-attention layer SSA may output a score function converted into a function related to probability by dot-multiplying the calculated query Q and key K and applying a SoftMax function to the product. Because the output score function may be multiplied by the calculated value V to obtain an input feature cube that is input to a subsequent 3D convolution layer 3D conv, the channel correlation for the image obtained by the multispectral image sensor 200 may be learned. As the image obtained by the multispectral image sensor 200 passes through two spatial attention blocks SAB, the 3D convolution layer 3D conv, the 3D pooling layer, and the fully connected layer, the deep learning network of FIG. 11A may estimate illumination information for the image obtained by the multispectral image sensor 200. The apparatus 100 according to the present embodiment may more accurately estimate illumination information for the image obtained by the multispectral image sensor 200, by using the deep learning network that is pre-trained on the channel correlation.

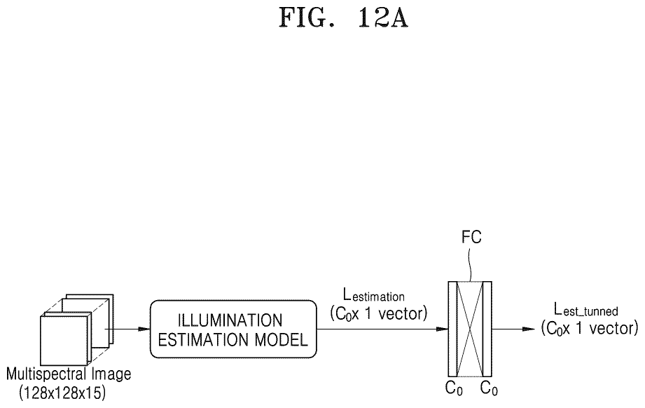

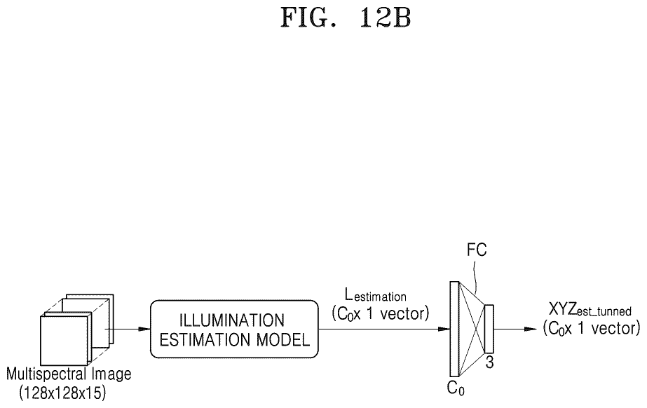

FIG. 12A is a diagram for describing an additional deep learning network according to an embodiment, and FIG. 12B is a diagram for describing an additional deep learning network according to another embodiment. Referring to FIGS. 12A and 12B, an illumination estimation model shown in FIGS. 12A and 12B represents a deep learning network including the convolution block CB shown in FIG. 6. The description of the deep learning network including the convolution block CB made with reference to FIG. 6 may equally apply to the illumination estimation model of FIGS. 12A and 12B, and the additional deep learning network of FIGS. 12A and 12B may use the illumination estimation model to estimate illumination information for the image obtained by the multispectral image sensor 200.

The additional deep learning network of FIG. 12A may be a network that further includes a fully connected layer having the same number of nodes equal to the dimension of an illumination vector corresponding to the estimated illumination information and is trained such that an output result output from the additional deep learning network may be close to hyper ground truth illumination information.

The additional deep learning network of FIG. 12B may be a network that further includes a fully connected layer having three nodes and is trained such that an output result output from the additional deep learning network may be close to XYZ ground truth illumination information.

The processor may transform an output result output from the additional deep learning network into an XYZ color space by using a color matching function and may perform auto white balance for the image obtained by the multispectral image sensor 200, by dividing elements of the output result of the additional deep learning network of FIG. 12B by elements of the output result of the additional deep learning network of FIG. 12A, respectively.

The apparatus according to the present embodiment may output illumination information that is closer to ground truth illumination information than illumination information estimated from the deep learning network including the convolution block CB, by using the additional deep learning network of FIG. 12A and the additional deep learning network of FIG. 12B. Accordingly, the apparatus according to the present embodiment may more accurately perform auto white balance for the image obtained by the multispectral image sensor 200.

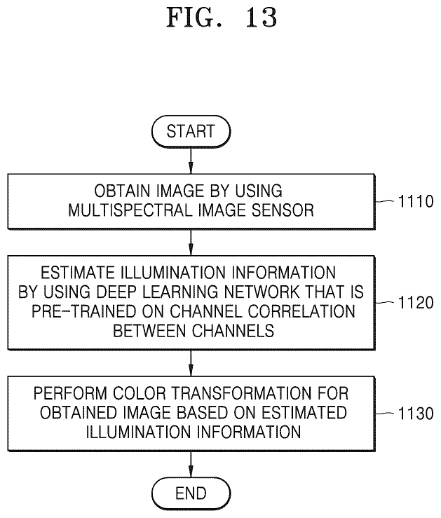

FIG. 13 is a flowchart for describing a method of obtaining an image, according to an embodiment.

Referring to FIG. 13, the method of obtaining an image includes operations processed by the apparatus 100 described with reference to FIGS. 1 to 12. Accordingly, the description of the apparatus 100 made above with reference to FIGS. 1 to 12 may also apply to the method of obtaining an image in FIG. 13.

The method of obtaining an image according to an embodiment may begin in operation 1110 by obtaining an image through four or more channels by using the multispectral image sensor 200.

The apparatus 100 may obtain channel signals that are output signals respectively corresponding to channels of the multispectral image sensor 200. The apparatus 100 may select at least some channels from among a certain number of channels physically provided in the multispectral image sensor 200 and obtain channel signals from the selected channels. For example, the apparatus 100 may obtain channel signals from all of the certain number of channels physically provided in the multispectral image sensor 200. Also, the apparatus 100 may obtain channel signals by selecting only some of the certain number of channels physically provided in the multispectral image sensor 200.

The apparatus 100 may also obtain an increased or decreased number of channel signals by synthesizing or interpolating channel signals obtained from the number of channels physically provided in the multispectral image sensor 200. For example, the apparatus 100 may obtain a multispectral image through four or more channels of the multispectral image sensor 200 or may obtain a hyperspectral image through nine or more channels. The apparatus 100 may obtain channel signals by selecting all or some of the channels physically provided in the multispectral image sensor 200, and the apparatus 100 may adjust the number of channel signals to be obtained, by synthesizing or interpolating the obtained channel signals.

In operation 1120, the apparatus 100 may estimate illumination information by using a deep learning network that is pre-trained on a channel correlation between channels. The apparatus 100 may input the image obtained from the multispectral image sensor 200 to the deep learning network that is pre-trained on the channel correlation between channels.

The deep learning network of the apparatus 100 may be trained in advance by using a supervised learning method. For example, the deep learning network may be trained by using illumination information, ground truth illumination information, and loss function, which are estimated for each of images input to the deep learning network. The deep learning network of the apparatus 100 may be pre-trained on a channel correlation between channels corresponding to the obtained image.

The deep learning network that is trained on the channel correlation may more accurately estimate illumination information by assigning different weights to respective signals obtained for channels according to the channel correlation between channels corresponding to an image input to the deep learning network.

For example, the deep learning network that is trained on the channel correlation may be a deep learning network including the channel attention block CAB. Because the apparatus 100 may be pre-trained on the channel correlation between channels corresponding to the image obtained from the multispectral image sensor 200 by using the deep learning network including the channel attention block CAB, illumination information for the image obtained from the multispectral image sensor 200 may be estimated more accurately.

The deep learning network including the channel attention block CAB may be trained by using supervised learning. For example, the deep learning network including the channel attention block CAB may optimize parameters of the deep learning network by using a backpropagation algorithm. The deep learning network including the channel attention block CAB may be trained by using a loss function including an AE. As the deep learning network is trained by using a backpropagation algorithm for an AE, learning efficiency may be improved, and the apparatus 100 including the deep learning network may more accurately estimate illumination information for the image obtained from the multispectral image sensor 200.

The deep learning network including the channel attention block CAB may be trained by using a hyper AE AE_{hyper} and an XYZ AE AE_{XYZ}. For example, as shown in Equation 3 below, the deep learning network may weighted-sum the hyper AE AE_{hyper} and the XYZ AE AE_{XYZ} in a certain ratio and use the weighted sum as a loss function.

Because the deep learning network is trained by using both the hyper AE AE_{hyper} and the XYZ AE AE_{XYZ}, illumination information measured by the multispectral image sensor 200, which is higher-dimensional than the illumination information transformed into the XYZ color space, may also be sufficiently learned. Accordingly, the apparatus 100 according to an embodiment may more accurately estimate illumination information for the image obtained from the multispectral image sensor 200, by estimating the illumination information by using the deep learning network that has been trained by using both the hyper AE AE_{hyper} and the XYZ AE AE_{XYZ}.

Also, because the deep learning network is trained by using, as a loss function, the weighted sum of the hyper AE AE_{hyper} and the XYZ AE AE_{XYZ}, the relationship between the illumination information measured by the multispectral image sensor 200 and the illumination information transformed into the XYZ color space may also be learned. Accordingly, the apparatus 100 according to an embodiment may more accurately estimate the illumination information transformed into the XYZ color space, by estimating the illumination information using the deep learning network that has been trained by weighted-summing the hyper AE AE_{hyper} and the XYZ AE AE_{XYZ} in a certain ratio and using the weighted sum as a loss function.

One or more illumination sources may be present in an environment where an image is captured by the apparatus 100. When the image obtained by the multispectral image sensor 200 is a mixed illumination image obtained in an environment where a first illumination source and a second illumination source, which are different from each other, are present, the apparatus 100 may use the deep learning network including two or more channel attention blocks CAB.

The apparatus 100 may divide the mixed illumination image obtained by the multispectral image sensor 200 into a region where the first illumination source is dominant and a region where the second illumination source is dominant. The apparatus 100 may estimate illumination information for the first illumination source by using the deep learning network for the region where the first illumination source is dominant in the mixed illumination image, and may estimate illumination information for the second illumination source by using the deep learning network for the region where the second illumination source is dominant in the mixed illumination image. The apparatus 100 may weighted-sum, in a certain ratio, a first illumination vector corresponding to the illumination information for the first illumination source and a second illumination vector corresponding to the illumination information for the second illumination source. In this case, a weighting coefficient is 0 or more, and a sum of weighting coefficients may be set to 1.

The channel attention block CAB of the apparatus 100 may include a pooling layer and a first fully connected layer. The apparatus 100 may perform global max pooling or global average pooling on the image obtained from the multispectral image sensor 200 and generate a first channel vector that constructs a maximum value or an average value of a global region of the image obtained from the multispectral image sensor 200 as vector elements.

The deep learning network may add the generated first channel vector to an output result of the first fully connected layer of the channel attention block CAB and then perform a convolution operation with the output feature map, which is the result of the convolution operation and output from the convolution layer conv.

The dimension of the generated first channel vector may be equal to the number of channels corresponding to the image obtained from the multispectral image sensor 200, but is not limited thereto. The dimension of the first channel vector may be adjusted to be greater than the number of channels corresponding to the image obtained from the multispectral image sensor 200. The deep learning network may adjust the dimension of the first channel vector by using the fully connected layer.

As the deep learning network inputs, to the output feature map output from the convolution layer conv, the first channel vector generated by performing global max pooling or global average pooling on the image obtained from the multispectral image sensor 200, the deep learning network may assign different weights respectively to signals obtained for each channel according to the channel correlation between channels corresponding to the image input to the deep learning network. Accordingly, the apparatus 100 may more accurately estimate illumination information for the image obtained from the multispectral image sensor 200.

In particular, as the deep learning network inputs, to the output feature map output from the convolution layer conv, the first channel vector generated by performing global average pooling on the image obtained from the multispectral image sensor 200, the apparatus 100 may more accurately estimate illumination information for an image captured in an environment where an illumination source with a narrow wavelength band is present.

The apparatus 100 may perform global max pooling or global average pooling on an intermediate image output from the intermediate convolution layer and generate a second channel vector that constructs a maximum value or an average value of a global or local region of the intermediate image with vector elements.

The dimension of the generated second channel vector may be equal to the number of channels corresponding to an output feature map output from the intermediate convolution layer, but is not limited thereto. The dimension of the second channel vector may be adjusted to be greater than the number of channels corresponding to the output feature map output from the intermediate convolution layer. The deep learning network may adjust the dimension of the second channel vector by using the fully connected layer.

As the deep learning network inputs, to the output feature map output from the intermediate convolution layer, the second channel vector generated by performing global max pooling, global average pooling, local max pooling, or local average pooling on the output feature map output from the intermediate convolution layer, the deep learning network may assign different weights respectively to signals obtained for each channel according to the channel correlation between channels corresponding to the image input to the deep learning network. Accordingly, the apparatus 100 may more accurately estimate illumination information for the image obtained from the multispectral image sensor 200.

In particular, as the deep learning network inputs, to the output feature map output from the intermediate convolution layer, the second channel vector generated by performing global average pooling or local average pooling on the output feature map output from the intermediate convolution layer, the apparatus 100 may more accurately estimate illumination information for an image captured in an environment where an illumination source with a narrow wavelength band is present.

The apparatus 100 may output illumination information estimated by the deep learning network in the form of a vector. The apparatus 100 may output the illumination information estimated by the deep learning network as an illumination vector corresponding to the estimated illumination information.

The dimension of the illumination vector output by the apparatus 100 may be equal to the number of channels corresponding to the image input to the deep learning network. However, the disclosure is not limited thereto. The apparatus 100 may adjust the dimension of the illumination vector to be greater than the number of channels corresponding to the image obtained by the multispectral image sensor 200, and the apparatus 100 may also adjust the dimension of the illumination vector to 3.

In operation 1130, the apparatus 100 may perform color transformation for the obtained image based on the estimated illumination information.

For example, the apparatus 100 may perform color transformation for the image obtained by the multispectral image sensor 200, by transforming each element of the illumination vector corresponding to the estimated illumination information into the XYZ color space by using a color matching function.

The apparatus 100 may perform auto white balance for the image obtained by the multispectral image sensor 200 based on the estimated illumination information.

However, an object for which the apparatus 100 performs color transformation and/or auto white balance based on the estimated illumination information is not limited to the image obtained by the multispectral image sensor 200. The apparatus 100 may perform color transformation and/or auto white balance for an image obtained by another image sensor based on the estimated illumination information.

The apparatus 100 may obtain estimated illumination information (hereinafter referred to as hyper illumination information) by inputting the image obtained by the multispectral image sensor 200 to the deep learning network, and may simultaneously obtain estimated illumination information (hereinafter referred to as RGB illumination information) by inputting an image obtained by the RGB sensor to the deep learning network.

The apparatus 100 may perform auto white balance for the image obtained by the RGB sensor, by transforming each element of a hyper illumination vector corresponding to the hyper illumination information into an XYZ value in the XYZ color space and then dividing each element of an RGB illumination vector corresponding to the RGB illumination information by each element of the illumination vector transformed into the XYZ value.

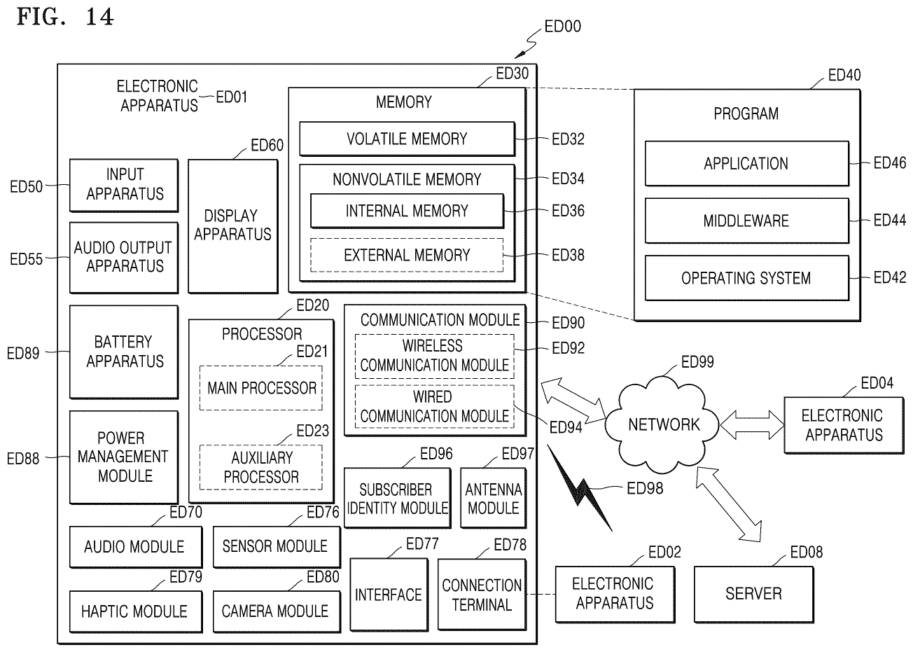

FIG. 14 is a block diagram of a configuration of an electronic apparatus ED01, according to an embodiment.

FIG. 14 is a block diagram illustrating a schematic structure of the electronic apparatus ED01, according to an embodiment. Referring to FIG. 14, in a network environment ED00, the electronic apparatus ED01 may communicate with another electronic apparatus ED02 through a first network ED98 (e.g., a short-distance wireless communication network) or may communicate with another electronic apparatus ED04 and/or a server ED08 through a second network ED99 (e.g., a long-distance wireless communication network). The electronic apparatus ED01 may communicate with the electronic apparatus ED04 via the server ED08. The electronic apparatus ED01 may include a processor ED20, a memory ED30, an input apparatus ED50, an audio output apparatus ED55, a display apparatus ED60, an audio module ED70, a sensor module ED76, an interface ED77, a haptic module ED79, a camera module ED80, a power management module ED88, a battery ED89, a communication module ED90, a subscriber identity module ED96, and/or an antenna module ED97. In the electronic apparatus ED01, some (e.g., the display apparatus ED60) of the components may be omitted, or another component may be added. Some of the components may be implemented as a single integrated circuit. For example, the sensor module ED76 (e.g., a fingerprint sensor, an iris sensor, an illuminance sensor, or the like) may be implemented by being embedded in the display apparatus ED60 (e.g., a display). Also, when an image sensor 1000 has a spectral function, some functions (e.g., a color function, an illuminance sensor, etc.) of the sensor module ED76 may be implemented in the image sensor 200 itself rather than in a separate sensor module.

The processor ED20 may execute software (e.g., a program ED40) to control one or a plurality of other components (e.g., hardware and software components) of the electronic apparatus ED01 connected to the processor ED20 and may perform various data processing or calculations. As some of the data processing or calculations, the processor ED20 may load, into a volatile memory ED32, commands and/or data received from another component (e.g., the sensor module ED76, the communication module ED90, or the like), process the commands and/or data stored in the volatile memory ED32, and store result data in a nonvolatile memory ED34. The processor ED20 may include a main processor ED21 (e.g., a central processing unit, an application processor, or the like) and an auxiliary processor ED23 (e.g., a graphics processing unit, an image signal processor, a sensor hub processor, a communication processor, or the like) that may operate independently or in conjunction with the main processor ED21. The auxiliary processor ED23 may use less power than the main processor ED21 and may perform a specialized function.

The auxiliary processor ED23 may control functions and/or states related to some components (e.g., the display apparatus ED60, the sensor module ED76, the communication module ED90, etc.) among the components of the electronic apparatus ED01, in place of the main processor ED21 while the main processor ED21 is in an inactive state (sleep state) or together with the main processor ED21 while the main processor ED21 is in an active state (application execution state). The auxiliary processor ED23 (e.g., an image signal processor, a communication processor, or the like) may also be implemented as part of another functionally related component (e.g., the camera module ED80, the communication module ED90, or the like).

The memory ED30 may store various types of data required by the components (e.g., the processor ED20, the sensor module ED76, etc.) of the electronic apparatus ED01. Data may include, for example, software (e.g., the program ED40), and input data and/or output data for a command related to the software. The memory ED30 may include the volatile memory ED32 and/or the nonvolatile memory ED34. The nonvolatile memory ED34 may include an internal memory ED36 mounted and fixed within the electronic apparatus ED01 and a removable external memory ED38.

The program ED40 may be stored as software in the memory ED30 and may include an operating system ED42, middleware ED44, and/or an application ED46.

The input apparatus ED50 may receive, from an external source (e.g., a user) of the electronic apparatus ED01, commands and/or data to be used in the components (e.g., the processor ED20) of the electronic apparatus ED01. The input apparatus ED50 may include a microphone, a mouse, a keyboard, and/or a digital pen (e.g., a stylus pen).

The audio output apparatus ED55 may output an audio signal to the outside of the electronic apparatus ED01. The audio output apparatus ED55 may include a speaker and/or a receiver. The speaker may be used for general purposes such as multimedia playback or recording playback, and the receiver may be used to receive incoming calls. The receiver may be integrated as part of the speaker or implemented as a separate independent apparatus.

The display apparatus ED60 may visually provide information to the outside of the electronic apparatus ED01. The display apparatus ED60 may include a display, a holographic apparatus, or a projector, and a control circuit for controlling a corresponding apparatus. The display apparatus ED60 may include a touch circuitry configured to detect a touch and/or a sensor circuit (e.g., a pressure sensor) configured to measure the magnitude of a force generated by the touch.

The audio module ED70 may convert sound into an electrical signal or convert an electrical signal into sound. The audio module ED70 may obtain sound through the input apparatus ED50 or output sound through the audio output apparatus ED55 and/or a speaker and/or a headphone of another electronic apparatus (e.g., the electronic apparatus ED02) directly of wirelessly connected to the electronic apparatus ED01.

The sensor module ED76 may detect an operating state (e.g., power, temperature, or the like) of the electronic apparatus ED01 or an external environmental state and generate an electrical signal and/or a data value corresponding to the detected state. The sensor module ED76 may include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface ED77 may support one or a plurality of designated protocols that may be used to directly or wirelessly connect the electronic apparatus ED01 to another electronic apparatus (e.g., the electronic apparatus ED02). The interface ED77 may include a high definition multimedia interface (HDMI), a universal serial bus (USB) interface, a secure digital (SD) card interface, and/or an audio interface.

A connection terminal ED78 may include a connector through which the electronic apparatus ED01 may be physically connected to another electronic apparatus (e.g., the electronic apparatus ED02). The connection terminal ED78 may include an HDMI connector, a USB connector, an SD card connector, and/or an audio connector (e.g., a headphone connector).

The haptic module ED79 may convert an electrical signal into a mechanical stimulation (e.g., vibration, movement, or the like) or an electrical stimulation that a use may perceive through tactile or kinesthetic senses. The haptic module ED79 may include a motor, a piezoelectric element, and/or an electrical stimulation apparatus.

The camera module ED80 may capture still images or shoot videos. The camera module ED80 may include the aforementioned apparatus 100 and may include an additional lens assembly, image signal processors, and/or flashes. The lens assembly included in the camera module ED80 may collect light emitted from a subject that is an object whose image is to be captured.

The power management module ED88 may manage power supplied to the electronic apparatus ED01. The power management module ED88 may be implemented as part of a power management integrated circuit (PMIC).

The battery ED89 may supply power to the components of the electronic apparatus ED01. The battery ED89 may include a non-rechargeable primary cell, a rechargeable secondary cell, and/or a fuel cell.

The communication module ED90 may establish a direct (wired) communication channel and/or a wireless communication channel between the electronic apparatus ED01 and another electronic apparatus (e.g., the electronic apparatus ED02, the electronic apparatus ED04, the server ED08, or the like) and support communication through the established communication channel. The communication module ED90 may include one or a plurality of communication processors that operate independently of the processor ED20 (e.g., an application processor) and support direct communication and/or wireless communication. The communication module ED90 may include a wireless communication module ED92 (e.g., a cellular communication module, a short-distance communication module, a global navigation satellite system (GNSS) communication module, or the like) and/or a wired communication module ED94 (e.g., a local area network (LAN) communication module, a power line communication module, or the like). A relevant communication module among these communication modules may communicate with another electronic apparatus through the first network ED98 (e.g., a short-distance communication network such as Bluetooth, WiFi Direct, or infrared data association (IrDA)) or the second network ED99 (e.g., a long-distance communication network such as a cellular network, the Internet, or a computer network (e.g., a LAN, a wide area network (WAN), or the like). These various types of communication modules may be integrated into one component (e.g., a single chip) or may be implemented as a plurality of separate components (e.g., a plurality of chips). The wireless communication module ED92 may identify and authenticate the electronic apparatus ED01 within a communication network such as the first network ED98 and/or the second network ED99 by using subscriber information (e.g., international mobile subscriber identifier (IMSI)) stored in the subscriber identity module ED96.

The antenna module ED97 may transmit signals and/or power to or receive signals and/or power from the outside (e.g., another electronic apparatus). An antenna may include a radiator including a conductive pattern formed on a substrate (e.g., a printed circuit board (PCB)). The antenna module ED97 may include one or a plurality of antennas. When the antenna module ED97 includes a plurality of antennas, the communication module ED90 may select an antenna suitable for a communication method used in a communication network such as the first network ED98 and/or the second network ED99 from among the plurality of antennas. Signals and/or power may be transmitted or received between the communication module ED90 and another electronic apparatus through the selected antenna. In addition to the antenna, another component (such as a radio frequency integrated circuit (RFIC)) may be included as part of the antenna module ED97.

Some of the components may be connected to each other and exchange signals (e.g., commands, data, etc.) with each other through a communication method (such as a bus, a general purpose input and output (GPIO), a serial peripheral interface (SPI), a mobile industry processor interface (MIPI), or the like) between peripheral apparatuses.

Commands or data may be transmitted or received between the electronic apparatus ED01 and the external electronic apparatus ED04 via the server ED08 connected to the second network ED99. The other electronic apparatuses ED02 and ED04 may be the same type of apparatus as or different types of apparatuses from the electronic apparatus ED01. All or some of operations executed by the electronic apparatus ED01 may be executed in one or a plurality of apparatus among the other electronic apparatuses ED02 and ED04 and the server ED08. For example, when the electronic apparatus ED01 needs to perform a certain function or service, instead of executing the function or service by itself, the electronic apparatus ED01 may request one or a plurality of other electronic apparatuses to perform part or all of the function or service. The one or the plurality of other electronic apparatuses that have received the request may execute an additional function or service related to the request and transmit a result of the execution to the electronic apparatus ED01. For this purpose, cloud computing, distributed computing, and/or client-server computing technologies may be used.

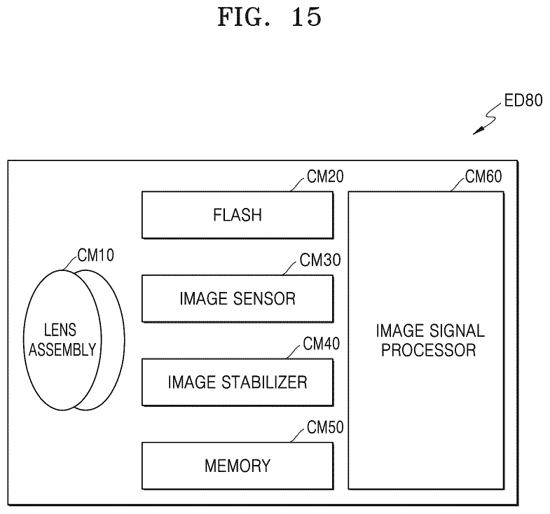

FIG. 15 is a block diagram of a camera module provided in the electronic apparatus of FIG. 14.

FIG. 15 is a schematic block diagram of the camera module ED80 provided in the electronic apparatus of FIG. 14. The camera module ED80 may include the aforementioned apparatus 100 or may have a structure modified therefrom. Referring to FIG. 15, the camera module ED80 may include a lens assembly CM10, a flash CM20, an image sensor CM30, an image stabilizer CM40, a memory CM50 (e.g., a buffer memory), and/or an image signal processor CM60.

The image sensor CM30 may be the image sensor 200 described above.

The lens assembly CM10 may collect light emitted from a subject that is an object whose image is to be captured. The camera module ED80 may also include a plurality of lens assemblies CM10. In this case, the camera module ED80 may include a dual camera, a 360-degree camera, or a spherical camera. Some of the plurality of lens assemblies CM10 may have the same lens property (e.g., an angle of view, focal length, autofocus, F number, optical zoom, or the like) or may have different lens properties. The lens assembly CM10 may include a wide-angle lens or a telephoto lens.

The lens assembly CM10 may be configured and/or focus-controlled such that an image sensor provided in the image sensor CM30 forms an optical image of the subject.

The flash CM20 may emit light that is used to enhance light emitted or reflected from the subject. The flash CM20 may include one or a plurality of light-emitting diodes (LEDs) (e.g., a RGB LED, a white LED, an infrared LED, an ultraviolet LED, etc.) and/or a xenon lamp.

In response to movement of the camera module ED80 or the electronic apparatus ED01 including the camera module ED80, the image stabilizer CM40 may ensure that negative effects caused by the movement are compensated, by moving the image sensor 1000 or one or a plurality of lenses included in the lens assembly CM10 in a specific direction or controlling operation characteristics of the image sensor 1000 (e.g., read-out timing adjustment). The image stabilizer CM40 may detect movement of the camera module ED80 or the electronic apparatus ED01 by using a gyro sensor or an acceleration sensor arranged inside or outside the camera module ED80. The image stabilizer CM40 may be implemented optically.

The memory CM50 may store part or all data of an image obtained through the image sensor 1000 for next image processing work. For example, when a plurality of images are obtained at high speed, obtained original data (e.g., Bayer-patterned data, high-resolution data, etc.) may be stored in the memory CM50 and used to display only low-resolution images and then transmit original data of selected (e.g., user-selected) images to the image signal processor CM60. The memory CM50 may be integrated into the memory ED30 of the electronic apparatus ED01 or may be configured as a separate memory that operates independently.

The image signal processor CM60 may perform image processing on images obtained through the image sensor CM30 or image data stored in the memory CM50.

In addition, the image processing may include depth map generation, 3D modeling, panorama generation, feature point extraction, image synthesis, and/or image compensation (e.g., noise reduction, resolution adjustment, brightness adjustment, blurring, sharpening, softening, or the like). The image signal processor CM60 may perform control (e.g., exposure time control, read-out timing control, or the like) on the components (e.g., the image sensor CM30) included in the camera module ED80. An image processed by the image signal processor CM60 may be stored again in the memory CM50 for further processing or may be provided to an external component (e.g., the memory ED30, the display apparatus ED60, the electronic apparatus ED02, the electronic apparatus ED04, the server ED08, or the like) of the camera module ED80. The image signal processor CM60 may be integrated into the processor ED20 or may be configured as a separate processor that operates independently of the processor ED20. When the image signal processor CM60 is configured as a separate processor from the processor ED20, the image processed by the image signal processor CM60 may be displayed through the display apparatus ED60 after undergoing additional image processing by the processor ED20.

The electronic apparatus ED01 may include a plurality of camera modules ED80 having different properties or functions. In this case, one of the plurality of camera modules ED80 may be a wide-angle camera and the other may be a telephoto camera. Similarly, one of the plurality of the camera modules ED80 may be a front camera and the other may be a rear camera.

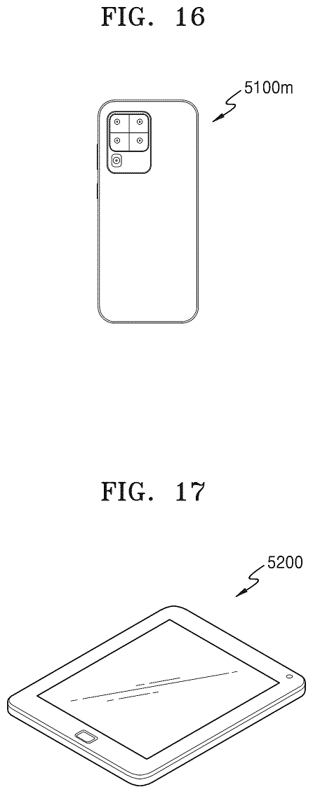

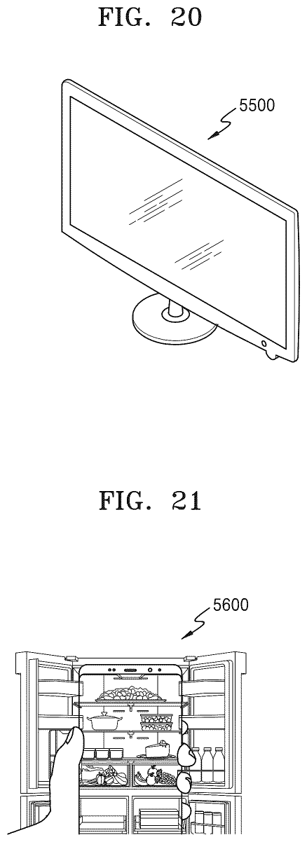

FIGS. 16 to 25 are diagrams illustrating various examples of an electronic apparatus to which an apparatus for obtaining an image is to be applied, according to various embodiments.

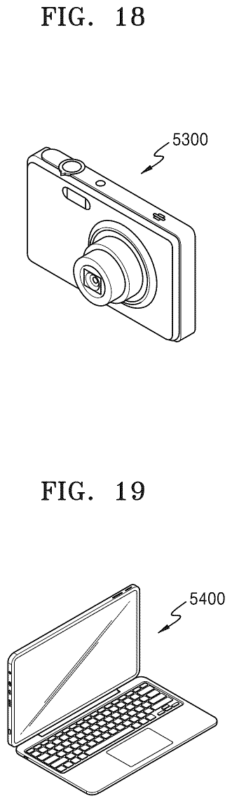

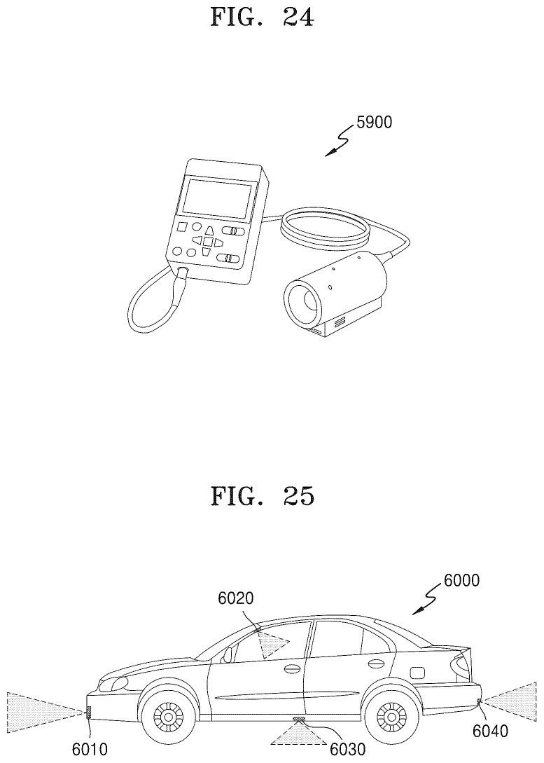

The apparatus according to embodiments may be applied to a mobile phone or smartphone 5100m shown in FIG. 16, a tablet or smart tablet 5200 shown in FIG. 17, a digital camera or camcorder 5300 shown in FIG. 18, a laptop computer 5400 shown in FIG. 19, or a television or smart television 5500 shown in FIG. 24. For example, the smartphone 5100m or the smart tablet 5200 may include a plurality of high-resolution cameras each equipped with a high-resolution image sensor. The high-resolution cameras may be used to extract depth information regarding subjects in an image, adjust out-focusing of an image, or automatically identify subjects in an image.

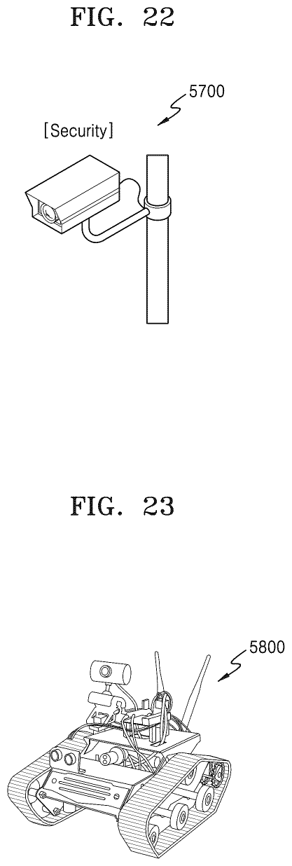

Also, the apparatus 100 may be applied to a smart refrigerator 5600 shown in FIG. 21, a security camera 5700 shown in FIG. 22, a robot 5800 shown in FIG. 23, or a medical camera 5900 shown in FIG. 24. For example, the smart refrigerator 5600 may automatically identify food present in the refrigerator by using the apparatus 100 and inform, through a smartphone, a user of the presence of specific food and the type of food put in and taken out from the refrigerator. The security camera 5700 may provide ultra-high resolution images and allow objects or people in an image to be recognized even in a dark environment by using high sensitivity. The robot 5800 may provide high-resolution images by being deployed at disaster or industrial sites where humans are unable to directly access. The medical camera 5900 may provide high-resolution images for diagnosis or surgery and may dynamically adjust the field of view.

Also, the apparatus 100 may be applied to a vehicle 6000 as shown in FIG. 25. The vehicle 6000 may include a plurality of vehicle cameras 6010, 6020, 6030, and 6040 arranged at various positions. Each of the vehicle cameras 6010, 6020, 6030, and 6040 may include an apparatus for obtaining an image according to an embodiment. The vehicle 6000 may provide various types of information about the inside or surroundings of the vehicle 6000 to a driver by using the plurality of vehicle cameras 6010, 6020, 6030, and 6040, and may provide information necessary for autonomous driving by automatically identifying objects or people in an image.

Moreover, the aforementioned method may be recorded on a computer-readable non-transitory recording medium having recorded thereon one or more programs including instructions that execute the method. Examples of a computer-readable recording medium include a magnetic medium such as a hard disk, a floppy disk, or a magnetic tape, an optical medium such as a CD-ROM or a digital video disc (DVD), a magneto-optical medium such as a floptical disk, and a hardware apparatus specially configured to store and execute program commands, such as ROM, RAM, or flash memory. Examples of the program commands include high-level language code that may be executed by a computer by using an interpreter or the like as well as machine language code made by a compiler.

Although the embodiments have been described in detail above, the scope of rights of the disclosure is not limited thereto. Various modifications and improvements made by those of ordinary skill in the art using the basic concept of the disclosure as defined in the following claims also fall within the scope of the disclosure.

It should be understood that the embodiments described herein should be considered in a descriptive sense only and not for purposes of limitation. Descriptions of features or aspects within each of the embodiments should typically be considered as available for other similar features or aspects in other embodiments. While one or more embodiments have been described with reference to the figures, it will be understood by one of ordinary skill in the art that various changes in form and details may be made therein without departing from the spirit and scope as defined by the following claims.

What is claimed is:

1. An apparatus for image processing, the apparatus comprising:
a multispectral image sensor configured to obtain an image through a plurality of channels; and
a processor configured to estimate illumination information by inputting the obtained image to a neural network and perform color transformation on the obtained image based on the estimated illumination information,
wherein the neural network is trained using a channel correlation between the plurality of channels to output the estimated illumination information.

2. The apparatus of claim 1, wherein the processor is further configured to input the channel correlation to at least one of a plurality of layers constituting the neural network.

3. The apparatus of claim 2, wherein the channel correlation comprises at least one of a first channel correlation between first channels and a second channel correlation between second channels, the first channels corresponding to the obtained image, and the second channels corresponding to an intermediate image output from one of the plurality of layers.

4. The apparatus of claim 1, wherein the neural network comprises:
a convolution block comprising a plurality of convolution layers; and
a channel attention block following at least one of the plurality of convolution layers,
wherein the channel attention block comprises a pooling layer and a first fully connected layer.

5. The apparatus of claim 4, wherein the processor is further configured to generate a first channel vector by performing global pooling on the image and add the first channel vector to an output result of the first fully connected layer.

6. The apparatus of claim 4, wherein the processor is further configured to generate a second channel vector by performing global pooling on an intermediate image output from a first convolution layer among the plurality of convolution layers,
the channel attention block follows a second convolution layer following the first convolution layer, and
the second channel vector is added to an output result of the first fully connected layer.

7. The apparatus of claim 4, wherein the channel attention block is configured to apply either one or both of a rectified linear unit (ReLU) function and a sigmoid function.

8. The apparatus of claim 1, wherein the neural network comprise at least one self-attention layer configured to learn the channel correlation.

9. The apparatus of claim 1, wherein the neural network is pre-trained by using a loss function including a first angular error and a second angular error,
the first angular error is based on first ground truth illumination information and first estimation illumination information regarding a training image for training the neural network, and
the second angular error is based on second illumination information and second estimation illumination information that are obtained by transforming the first ground truth illumination information and the first estimation illumination information into an XYZ color space by using color matching function, respectively.

10. The apparatus of claim 1, wherein, when the obtained image is a mixed illumination image obtained from an environment where a first illumination source and a second illumination source are present, the processor is further configured to divide the mixed illumination image into divided regions, estimate first illumination information based on a first region where the first illumination source is dominant among the divided regions, estimate second illumination information based on a second region where the second illumination source is dominant among the divided regions, and estimate mixed illumination information regarding the mixed illumination image based on the first illumination information and the second illumination information.

11. The apparatus of claim 1, wherein the processor is further configured to adjust a dimension of an illumination vector corresponding to the estimated illumination information to be greater than a number of channels corresponding to the obtained image or adjust the dimension of the illumination vector to 3.

12. The apparatus of claim 1, wherein the neural network comprises:
a three-dimensional (3D) convolution layer configured to perform 3D convolution based on the plurality of channels and a two-dimensional (2D) image corresponding to the obtained image; and
a spectral channel attention block following the 3D convolution layer.

13. The apparatus of claim 12, wherein the neural network further comprises a spectral self-attention layer configured to learn the channel correlation.

14. A method for image processing, the method comprising:
obtaining an image through a plurality of channels by using a multispectral image sensor;
estimating illumination information by inputting the obtained image to a neural network; and
based on the estimated illumination information, performing color transformation for the obtained image,
wherein the neural network is trained using a channel correlation between the plurality of channels to output the estimated illumination information.

15. The method of claim 14, wherein the estimating of the illumination information further comprises:
inputting the obtained image to the neural network; and
inputting the channel correlation to at least one of a plurality of layers constituting the neural network.

16. The method of claim 15, wherein the channel correlation comprises at least one of a first channel correlation between first channels and a second channel correlation between second channels, the first channels corresponding to the obtained image, and the second channels corresponding to an intermediate image output from at least one of the plurality of layers.

17. The method of claim 14, wherein the neural network comprises:
a convolution block comprising a plurality of convolution layers; and
a channel attention block following at least one of the plurality of convolution layers,
wherein the channel attention block comprises a pooling layer and a first fully connected layer.

18. The method of claim 17, wherein the estimating of the illumination information further comprises:
generating a first channel vector by performing global pooling on the obtained image; and
adding the first channel vector to an output result of the first fully connected layer.

19. The method of claim 17, wherein the estimating of the illumination information further comprises:
generating a second channel vector by performing global pooling on an intermediate image output from a first convolution layer among the plurality of convolution layers; and
adding the second channel vector to an output result of the first fully connected layer,
wherein the channel attention block follows a second convolution layer following the first convolution layer.

20. The method of claim 14, wherein the estimating of the illumination information further comprises adjusting a dimension of an illumination vector corresponding to the estimated illumination information to be greater than a number of channels corresponding to the obtained image or adjusting the dimension of the illumination vector to 3.
